(19) United States
(12) Patent Application Publication
(10) Pub. No.: US 2008/0190907 A1
(43) Pub. Date: Aug. 14, 2008

(54) Method of Connecting Metal Material

(75) Inventors: Hidetoshi Fujii, Osaka (JP); Lin Cui, Osaka (JP); Shigeki Matsuoka, Kanagawa (JP); Takeshi Ishikawa, Kanagawa (JP); Kazuo Genchi, Kanagawa (JP)

Correspondence Address: OSHA LIANG L.L.P., 1221 MCKINNEY STREET, SUITE 2800, HOUSTON, TX, 77010, US

(73) Assignees: Hidetoshi Fujii, Suita-shi (JP); Tokyu Car Corporation, Yokohama-shi (JP)

(21) Appl. No.: 11/579,217

(22) PCT Filed: Mar. 14, 2005
(86) PCT No.: PCT/JP05/04463

§ 371 Date: Oct. 17, 2007

(30) Foreign Application Priority Data
Apr. 30, 2004 (JP) 2004-136240
Aug. 10, 2004 (JP) 2004-233741
Aug. 13, 2004 (JP) 2004-236146
Nov. 25, 2004 (JP) 2004-341172
Mar. 2, 2005 (JP) 2005-058099

(51) Int. Cl. B23K 9/00

(52) U.S. Cl. 219/137 WM

(57) ABSTRACT

A method of connecting metal materials to each other, wherein a pin fitted to the tip of a metal bar-like rotating tool (10) is inserted between the end pan of a metal member (I) and the end part of a metal member (1′), and moved, while rotating, along the longitudinal direction of these end parts. By this frictional heat is generated between the metal members (1) and (1′) and the rotating tool (10), and the metal member (1) is connected to the metal member (1′). The rotating tool (10) is formed of a wide shoulder (12) and a thin pin (11) formed at the tip thereof and inserted between the end parts of the metal members. The pin (11) is a right circular cylindrical pin. The side face of the pin (11) is formed in a smooth curved surface, and a thread groove is not formed therein.

### TECHNICAL FIELD

The present invention relates to a method for welding metals.

### BACKGROUND ART

There are variations of methods for welding metals. Friction stir welding (FSW) method is one of them, disclosed in Patent Document 1 (Japanese Patent No. 2712838) and Patent Document 2 (Japanese Patent No. 2792233). The friction stir welding method welds two metallic members to be welded by butting each edge thereof, and by inserting a pin formed at front end of a rotary tool in between the butted edges, and then by moving the pin along the longitudinal direction of the edges while rotating the rotary tool.

The pin of the rotary tool used for the friction stir welding method has thread grooves on the side face of the pin. For example, FIGS. 1, 2, 12, and 13 of the Patent Document 1 are merely schematic drawings so that they give no detail of the thread grooves on the pin. Actually, however, as shown in FIG. 2 of Patent Document 2, the thread grooves are formed on the side face of the pin of the rotary tool. The thread grooves are formed aiming to stir the metal material which shows plasticity by friction, thus to flow along the longitudinal direction of the pin, thereby improving the welding strength.

### DISCLOSURE OF THE INVENTION

The rotary tool having thread grooves on the pin, however, likely wears the thread grooves, thus that type of rotary tool has a drawback of short life. Particularly when the friction stir welding is applied to metallic members made of hard metal material or when the friction stir welding is given over a long welding length, the tendency becomes significant. In addition, the working to form thread grooves on the pin of the rotary tool is troublesome, which leads to high production cost of the rotary tool.

In this regard, the present invention provides a method for welding metals, which improves the life of rotary tool and which lightens the load to troublesome manufacture of rotary tool and reduces the manufacturing cost.

The present invention contains the steps of (a) butting two metallic members at each side edge thereof, and (b) inserting a pin in a right-cylindrical shape formed at the front end of a rod-shaped rotary tool between the respective side edges of the metallic members, thereby moving the pin along the longitudinal direction of the edges while rotating the rotary tool.

According to the present invention, there is formed no thread groove, which is easily worn, on the pin, thus the life of the rotary tool is prolonged. In addition, since there is no need of forming thread groove on the pin, the manufacturing cost of the rotary tool decreases.

The term “right-cylindrical shape” referred to herein signifies a cylindrical shape without thread on the side face of the cylinder, or on the cylinder surface. The “right-cylindrical shape” includes a cylindrical shape having the side face thereof formed by straight line generatrices perpendicular to the bottom face. The pin of the “right-cylindrical shape” includes the one that has R between the bottom face and the side face at top of the pin. The pin in a “right-cylindrical shape” also includes the one in which the bottom face itself at top of the pin is in R shape.

In addition, the pin of the rotary tool may be a pin having side face formed by straight line generatrices. The term “pin having side face formed by straight line generatrices” signifies a pin having, for example, cylindrical, conical, or truncated cone shape.

### BRIEF DESCRIPTION OF THE DRAWINGS

FIG. 1 illustrates the method for welding metals according to a first embodiment of the present invention.

FIG. 2 shows the front end of a rotary tool with a pin in a triangular prism shape.

FIG. 3 shows the front end of a rotary tool with a pin in a hexagonal prism shape.

FIG. 4 shows the front end of a rotary tool with a pin having thread grooves thereon.

FIG. 5 shows the tensile strength of welded A1050 materials.

FIG. 6 shows the 0.2% proof stress of welded A1050 materials.

FIG. 7 shows the elongation of welded A1050 materials.

FIG. 8 shows the result of tensile test at welded part of A6N01 materials.

FIG. 9 shows the tensile strength of A5083 materials welded at a rotational speed of 1500 rpm.

FIG. 10 shows the tensile strength of A5083 materials welded at a rotational speed of 800 rpm.

FIG. 11 shows the 0.2% proof stress of A5083 materials welded at a rotational speed of 800 rpm.

FIG. 12 shows the elongation of A5083 materials welded at a rotational speed of 800 rpm.

FIG. 13 shows the tensile strength of A5083 materials welded at a rotational speed of 600 rpm.

FIG. 14 shows the 0.2% proof stress of A5083 materials welded at a rotational speed of 600 rpm.

FIG. 15 shows the elongation of A5083 materials welded at a rotational speed of 600 rpm.

FIG. 16 shows cross sections of welded part of A5083 materials.

FIG. 17 shows the result of tensile test at welded part of A2017 materials.

FIG. 18 shows the result of tensile test at welded part of A2017 materials, using the rotary tool with thread grooves and the rotary tool without thread groove, varying the rotational speed thereeach.

FIG. 19 shows the tensile strength of welded A6061 materials.

FIG. 20 shows the 0.2% proof stress of welded A6061 materials.

FIG. 21 shows the elongation of welded A6061 materials.

FIG. 22 shows the composition of composite material relating to Experimental Example 6.

FIG. 23 shows the original size, before welding, of the rotary tool relating to Experimental Example 6.

FIG. 24 shows the table of conditions for every welding cycle using the rotary tool with thread grooves in Experimental Example 6.

FIG. 25 shows the table of conditions for every welding cycle using the rotary tool without thread groove in Experimental Example 6.

FIG. 26 shows the changes in appearance of the rotary tool with thread grooves in Experimental Example 6.

FIG. 27 is the graphs showing the changes of rotary tool with thread grooves in Experimental Example 6.

FIG. 28 is the graphs showing the changes of rotary tool with thread grooves in Experimental Example 6.

FIG. 29 shows the changes in appearance of the rotary tool without thread groove in Experimental Example 6.

FIG. 30 is the graphs showing the changes of rotary tool without thread groove in Experimental Example 6.

FIG. 31 is the graphs showing the changes of rotary tool without thread groove in Experimental Example 6.

FIG. 32 illustrates the rotary tool with a pin having a top in a conical shape, used in Experimental Example 7.

FIG. 33 illustrates the rotary tool with a pin having a top in a spherical shape, used in Experimental Example 7.

FIG. 34 illustrates the rotary tool with a pin having a top in a polygonal prism shape, used in Experimental Example 7.

FIG. 35 shows the result of tensile test at the welded part of SUS304 materials, using the rotary tool with a pin having a top in a conical shape.

FIG. 36 shows the result of elongation test at the welded part of SUS304 materials, using the rotary tool with a pin having a top in a conical shape.

FIG. 37 shows the result of tensile test at the welded part of SUS304 materials, using the rotary tool with a pin having a top in a spherical shape.

FIG. 38 shows the result of elongation test at the welded part of SUS304 materials, using the rotary tool with a pin having a top in a spherical shape.

FIG. 39 shows the result of tensile test at welded part of SUS304 materials, using the rotary tool with a pin having a top in a polygonal prism shape.

FIG. 40 shows the result of elongation test at welded part of SUS304 materials, using the rotary tool with a pin having a top in a polygonal prism shape.

FIG. 41 shows the result of tensile test at welded part of SUS301L-DLT materials, using the rotary tool with a pin having a top in a conical shape.

FIG. 42 shows the result of tensile test at welded part of SUS301L-DLT materials, using the rotary tool with a pin having a top in a spherical shape.

FIG. 43 shows the result of elongation test at welded part of SUS301L-DLT materials, using the rotary tool with a pin having a top in a spherical shape.

FIG. 44 shows the result of tensile test at welded part of SUS301L-DLT materials, using the rotary tool with a pin having a top in a polygonal prism shape.

FIG. 45 shows the result of elongation test at welded part of SUS301L-DLT materials, using the rotary tool with a pin having a top in a polygonal prism shape.

FIG. 46 shows the cross sections of welded part in Experimental Example 7, at various welding speeds, rotational speeds, and rotational pitches.

FIG. 47 shows a comparative table summarizing the results of Experimental Examples 1 to 5.

FIG. 48 shows a comparative table summarizing the results of Experimental Example 6.

FIG. 49 shows a comparative table summarizing the results of Experimental Example 7.

FIG. 50 illustrates the method for welding metals relating to the second embodiment of the present invention.

### BEST MODES FOR CARRYING OUT THE INVENTION

The embodiments of the present invention are described below referring to the drawings.

### First Embodiment

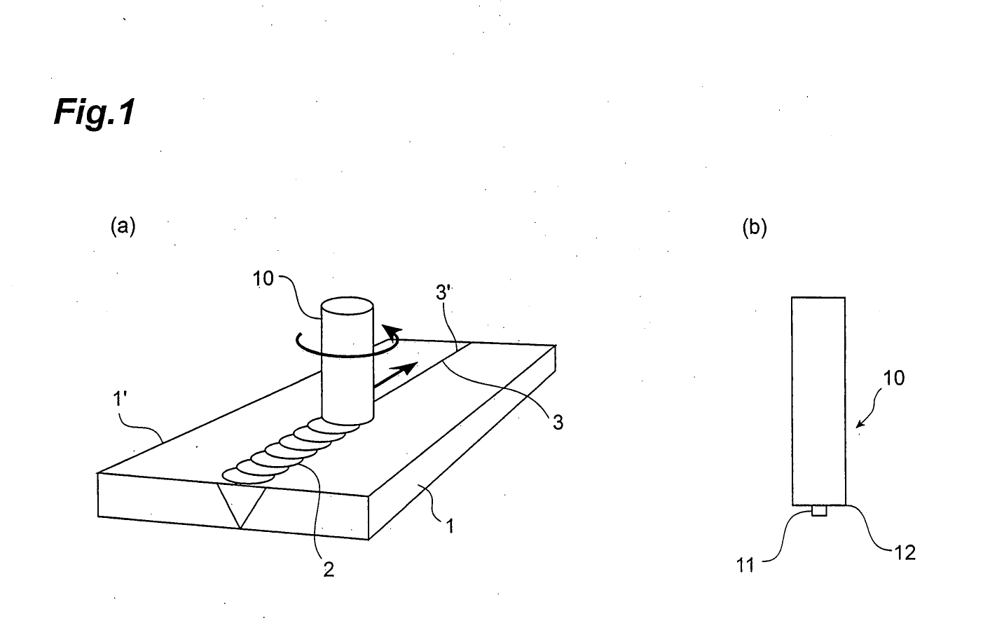

FIG. 1 illustrates the method for welding metals according to the first embodiment of the present invention. In FIG. 1, FIG. 1(a) shows the state of friction stir welding in the method for welding metals according to the first embodiment of the present invention, and FIG. 1(b) shows a side view of the rotary tool used in the method for welding metals according to the first embodiment of the present invention.

The method for welding metals relating to the first embodiment is based on the friction stir welding method. As shown in FIG. 1(a), the friction stir welding proceeds by butting an edge part 3 of a metallic member 1 against an edge part 3′ of a metallic member 1′, and by inserting a pin 11 formed at the front end of a rotary tool 10 in a rod shape in between the butted edges 3 and 3′, and then by moving the pin 11 along the longitudinal direction of the edges 3 and 3′ while rotating the pin 11. The friction stir welding welds the metallic member 1 with the metallic member 1′ using the friction heat generated between the rotary tool 10 and each of the metallic members 1 and 1′.

The related art is the friction stir welding method which uses a rotary tool with a pin having thread grooves thereon to enhance the stirring of metal material. On the other hand, the method for welding metals according to the first embodiment differs from the conventional friction stir welding method in using the rotary tool 10 shown in FIG. 1(b).

The rotary tool 10 is structured by a wide shoulder 12 and a thin pin 11 which is formed at the front end of the shoulder 12 and which is inserted between the edges of the respective metallic members. The pin 1i is in a right-cylindrical shape. The side face of the pin 11 is in a smooth curved face, and has no thread groove thereon. Here, the shoulder 12 is in a cylindrical shape having larger diameter than that of the pin 11, and extends in the axial direction of the pin 11. The pin 11 is formed at the front end of the shoulder 12, or at an end face of the shoulder 12.

The inventors of the present invention found that also the method for welding metals using the rotary tool with a pin having no thread groove thereon, according to the first embodiment, can attain a welding strength at the welded part equal to or higher than the welding strength attained in the related art. The term “welded part” referred to herein signifies the part in the vicinity of the welding line on the metallic members after welding.

Since the pin used in the welding method according to the first embodiment has no thread groove thereon, there is no fear of wearing the thread grooves. Consequently, the pin life prolongs. Furthermore, since there is no need of forming thread grooves on the pin, the work for manufacturing the rotary tool becomes easy. In addition, the number of steps for manufacturing the rotary tool decreases, thus the rotary tool becomes inexpensive.

A presumable reason for the welding method of the first embodiment to attain equivalent welding strength to that attained by the conventional methods is that, without providing the thread groove on the pin, the plastic flow of the metal material along the rotational direction of the pin becomes larger than the plastic flow thereof along the longitudinal direction of the pin, which increases the welding strength. In addition, the conventional understanding is that the thread grooves on the pin enhance the stirring of metal material. Actually, however, a pin in a right-cylindrical shape and having smooth side face such as the pin in the first embodiment might rather enhances the stirring of the metal material.

The experimental results obtained by the welding method according to the first embodiment are described below.

### EXPERIMENTAL EXAMPLE 1

With a rotary tool shown in FIG. 1(b), A1050 materials specified in JIS H 4000 were welded together by the friction stir welding method illustrated in FIG. 1(a). The A1050 materials used in Experimental Example 1 were plates having a thickness of 5 mm. The rotational speed of the rotary tool was 1500 rpm. The welding speed, or the moving speed of the rotary tool was varied between 25 and 800 mm/min. The rotary tool had a shoulder diameter of 15 mm, a pin length of 4.7 mm, and a pin diameter of 6 mm.

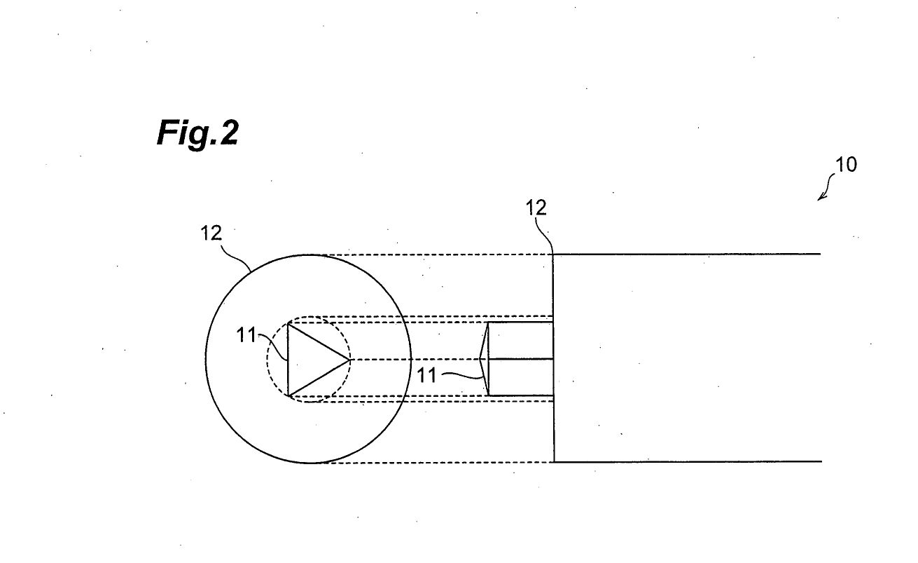

Separately, a rotary tool with a pin in a regular-triangular prism shape, shown in FIG. 2, and a rotary tool with a pin in a regular-hexagonal prism shape were used to weld the A1050 materials, respectively, under the above condition.

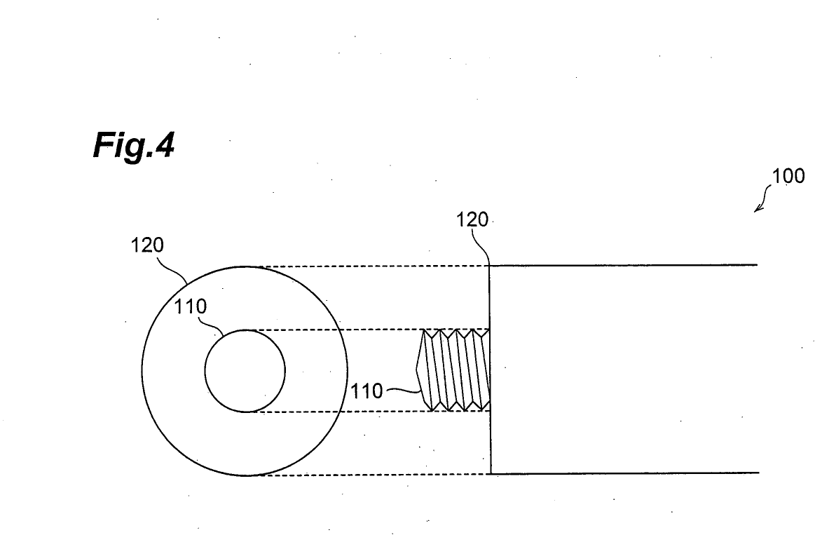

For comparison, a conventional method using a rotary tool 100 with a pin 110 having thread grooves thereon, shown in FIG. 4, was used to weld the A1050 materials under the same condition.

Here, the A1050 material is an Al material having 99.50% or higher purity. The material has good formability, weldability, and corrosion resistance, though the strength is low. The tensile strength thereof is 106 MPa, and the 0.2% proof stress is 68 MPa.

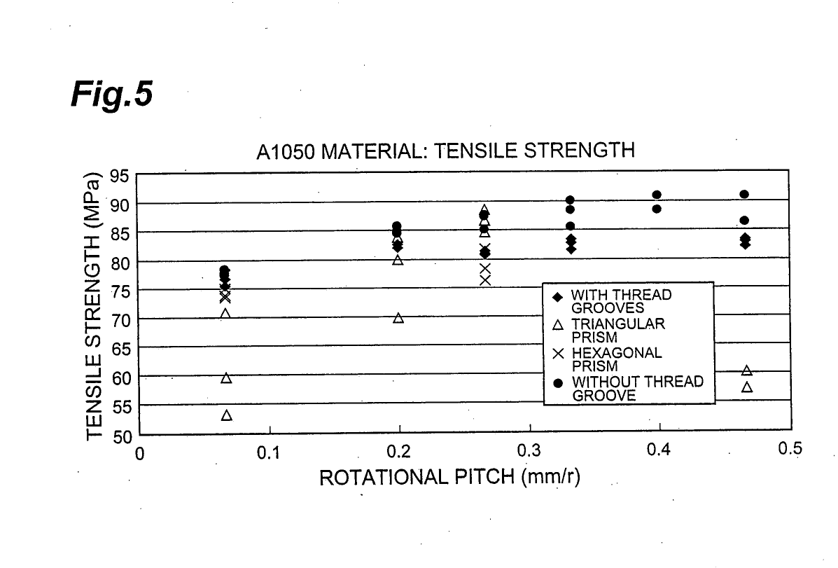

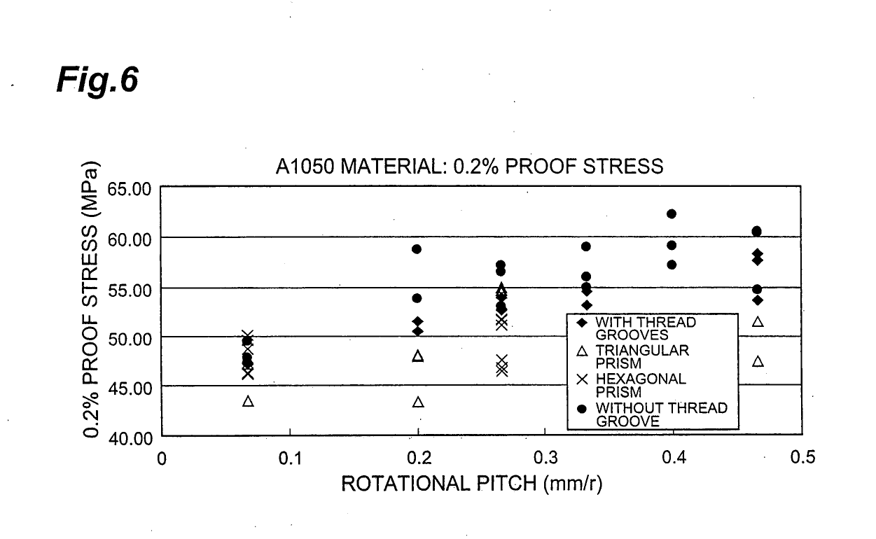

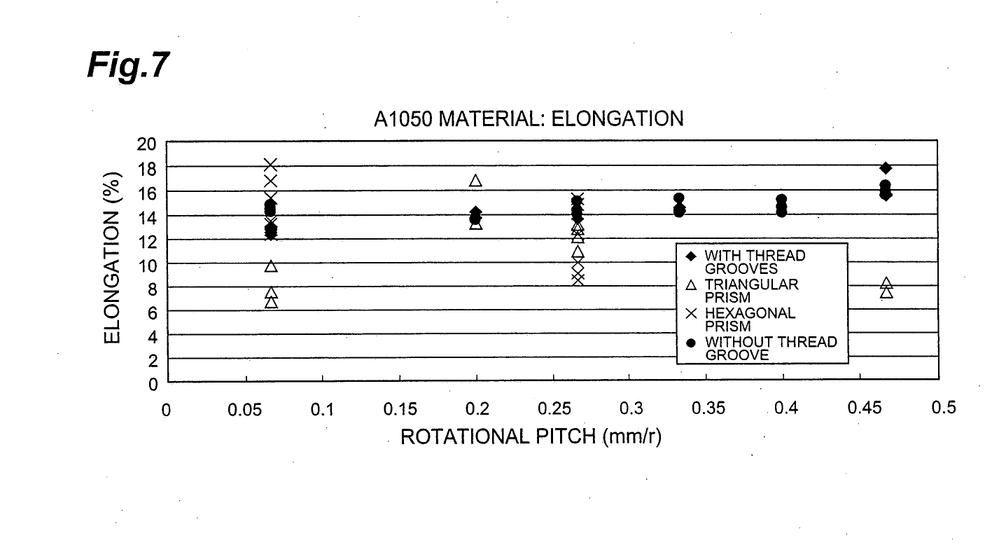

FIG. 5 shows the tensile strength of the welded A1050 materials. As seen in FIG. 5, the tensile strength at the welded part obtained by welding the A1050 materials, which is an Al material of mild and weak-strength, using a rotary tool with a pin having no thread groove thereon increased by about 10% (from 80 MPa to 90 MPa) within a range of 0.07 to 0.47 of the rotational pitch [mm/r] or (the welding speed [mm/min]/the rotational speed of the rotary tool [rpm]), compared with the tensile strength at the welded part obtained by conventional method using the rotary tool having thread grooves. In addition, as shown in FIG. 6, according to the welding method of the first embodiment, the 0.2% proof stress was also increased. Furthermore, as seen in FIG. 7, the elongation showed similar tendency to above.

In addition, as shown in FIG. 5, the welding method of the first embodiment performed particularly favorable welding of A1050 materials at or above 0.28 [mm/r] of the rotational pitch.

From the above results, it was confirmed that the welding method of the first embodiment favorably welds the A1050 materials at or above 2.41×10³ of {(the rotational speed of the rotary tool [rpm]×the shoulder diameter [mm]³)/the moving speed of the rotary tool [mm/min]/the plate thickness [mm]}.

As described above, the welding method of the first embodiment is specifically effective for welding mild and weak-strength metals such as A1050 materials. For that mild and weak-strength metals, effective cases are the welding of relatively mild and weak-strength metals having the 0.2% proof stress of 200 MPa or smaller at the friction stir-welded part, preferably 150 MPa or smaller, and more preferably 70 MPa or smaller.

### EXPERIMENTAL EXAMPLE 2

With the rotary tool shown in FIG. 1(b), A6N01 materials specified in JIS H 4100 were welded together by the friction stir welding, illustrated in FIG. 1(a). The A6N01 materials used in Experimental Example 2 were plates having a thickness of 3.1 mm. The rotational speed of the rotary tool was 1000 rpm. The welding speed was varied between 200 and 1000 mm/min. The rotary tool had a shoulder diameter of 12 mm, a pin length of 2.9 mm, and a pin diameter of 4 mm.

Further, the conventional method using a rotary tool with a pin having thread grooves thereon, (refer to FIG. 4), was used to weld the A6N01 materials under the same condition.

Here, the A6N01 material is a heat-treated alloy containing an alloying element of compound of Mg and Si, which gives significant strength, while attaining good extrudability, formability, and corrosion resistance, giving 267 MPa of tensile strength and 235 MPa of 0.2% proof stress.

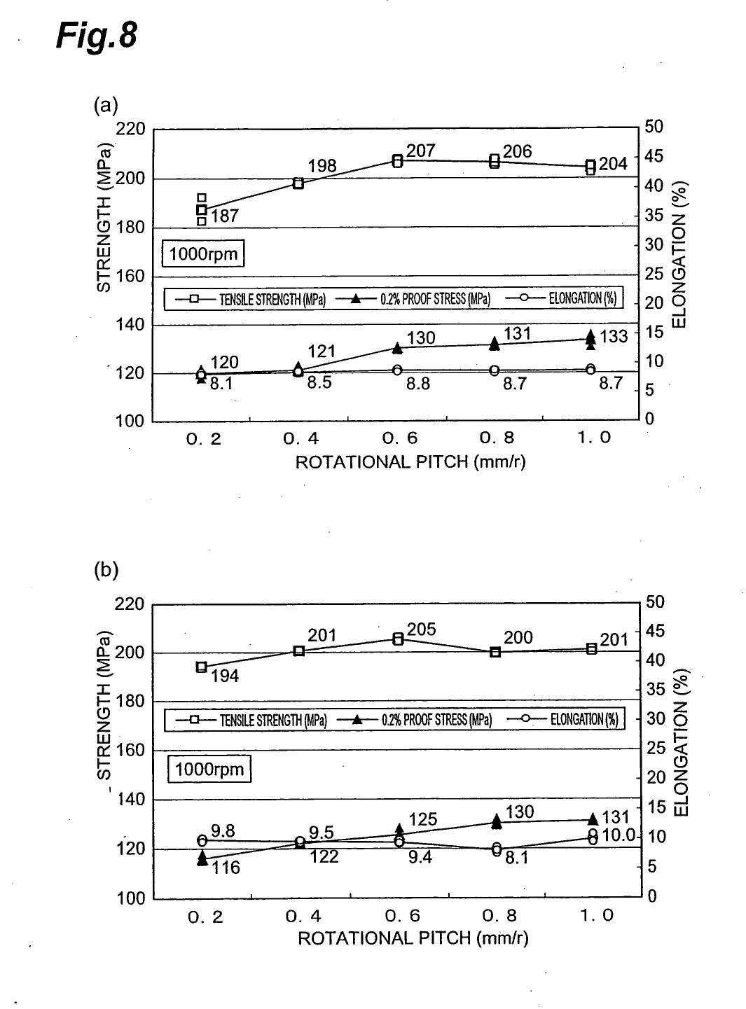

FIG. 8 shows the result of tensile test at welded part of A6N01 materials. FIG. 8(a) shows the result of tensile test at the welded part of A6N01 materials obtained by the method of the first embodiment. FIG. 8(b) shows the result of tensile test at the welded part of A6N01 materials obtained by the conventional method.

As seen in FIG. 8, the tensile strength at the welded part of A6N01 materials obtained by the welding method of the first embodiment was equivalent to the tensile strength at the welded part of A6N01 materials obtained by the conventional method, at 0.2 [mm/r] (200 mm/min, 1000 rpm) or larger rotational pitch, specifically 0.3 [mm/r] (300 mm/min, 1000 rpm) or larger.

Further the welding method of the first embodiment attained a welded part of A6N01 materials giving almost equal 0.2% proof stress and elongation to those at the welded part obtained by the conventional method at the rotational pitches in a range from 0.2 to 1.0 [mm/r], specifically 0.3 [mm/r] or larger.

From the above results, it is concluded that, even with the welding of metals having medium degree of hardness and strength, such as A6N01 materials, the welding strength equivalent to that of the case using the conventional rotary tool with a pin having thread grooves thereon by adjusting the rotational pitch to 0.2 [mm/r] or more, or adjusting the welding speed to 200 mm/min or less, specifically 0.3 [nm/r] or larger rotational pitch, or 300 mm/min or larger welding speed.

Here, it is known that the heat-input to a metallic member is proportional to the rotational speed of the rotary tool and to the cube of the shoulder diameter of the rotary tool, and is inversely proportional to the welding speed. As a result, it was found that the A6N01 materials are favorably welded together when the value of {(the rotational speed of the rotary tool [rpm] ×the shoulder diameter [mm]³)/the moving speed of the rotary tool [mm/min]/the plate thickness [mm]} is 1.86×10³ or larger.

According to the welding method of the first embodiment, it is also expected that the decrease in the rotational speed of the rotary tool provides a welding strength equivalent to that obtained by the conventional method, as described in Experimental Example 3, given later.

As mentioned above, according to the welding method of the first embodiment, the A6N01 materials can be welded together giving equivalent welding strength to that obtained by the conventional method. The method is therefore applicable to, for example, manufacturing body structures of vehicle of railway using A6N01 materials.

### EXPERIMENTAL EXAMPLE 3

With the rotary tool shown in FIG. 1(b), A5083 materials specified in JIS H 4000 were welded together by the friction stir welding method, illustrated in FIG. 1(a). The A5083 materials used in Experimental Example 1 were plates having a thickness of 5 mm. The rotational speed of the rotary tool was 1500 rpm. The welding speed was varied between 25 and 800 mm/min. The rotary tool had a shoulder diameter of 15 mm, a pin length of 4.7 mm, and a pin diameter of 6 mm.

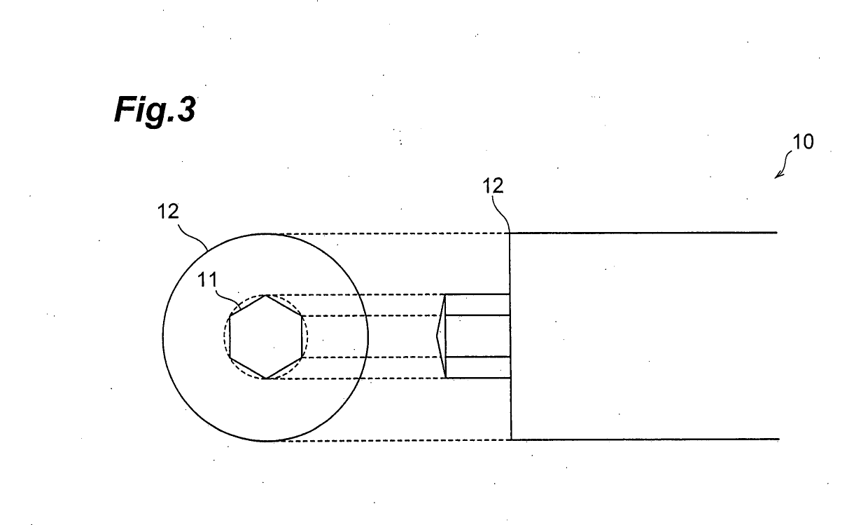

Further, separately, a rotary tool with a pin in a regular-triangular prism shape, shown in FIG. 2, and a rotary tool with a pin in a regular-hexagonal prism shape, shown in FIG. 3, were used to weld the A5083 materials, respectively, under the same condition.

Further, a conventional method using a rotary tool with a pin having thread grooves thereon, (refer to FIG. 4), was used to weld the A5083 materials under the same condition.

Here, the A5083 material is a member of not-heat-treated alloy prepared by adding only Mg to Al in a large quantity, having the highest strength among the not-heat-treated alloys, while providing favorable weldability. The tensile strength thereof is 355 MPa and the 0.2% proof stress is 195 MPa.

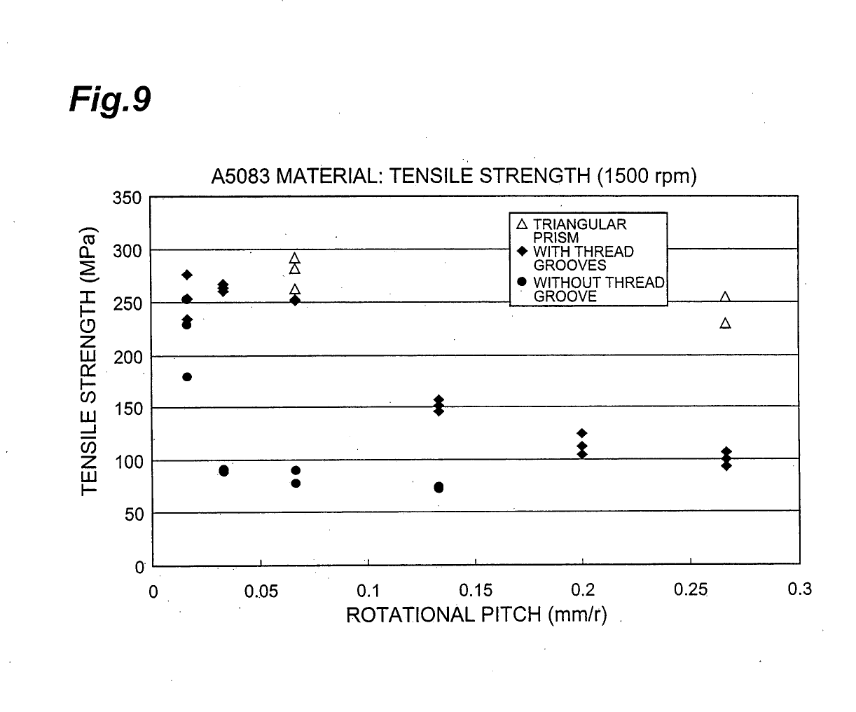

FIG. 9 shows the tensile strength of A5083 materials welded at a rotational speed of 1500 rpm. As seen in FIG. 9, compared with the welded part obtained by the conventional method, the welded part of the A5083 materials obtained by the welding method of the first embodiment gave no improvement in the tensile strength in a range of rotational pitch from 0.02 to 0.3 [mm/r].

Besides, FIG. 9 shows that the welding strength at the welded part obtained by a rotary tool with a pin in a triangular prism shape, at a rotational speed of 1500 rpm, is superior to rotary tools with pins in other shapes.

Separately, A5083 materials were welded together using the method of the first embodiment under the same conditions except for decreasing the rotational speed of the rotary tool to 500 rpm. The result gave a tensile strength of 300 MPa, which is strength equivalent to that in the conventional case of using a rotary tool with a pin having thread grooves thereon.

To conduct further detail study of the relation between the welding strength and the rotational speed of the rotary tool, A5083 materials were welded together varying the rotational speed of the rotary tool. The rotational speed of the rotary tool was varied, 600 and 800 rpm, and the welding speed was varied in a range from 25 to 216 mm/min.

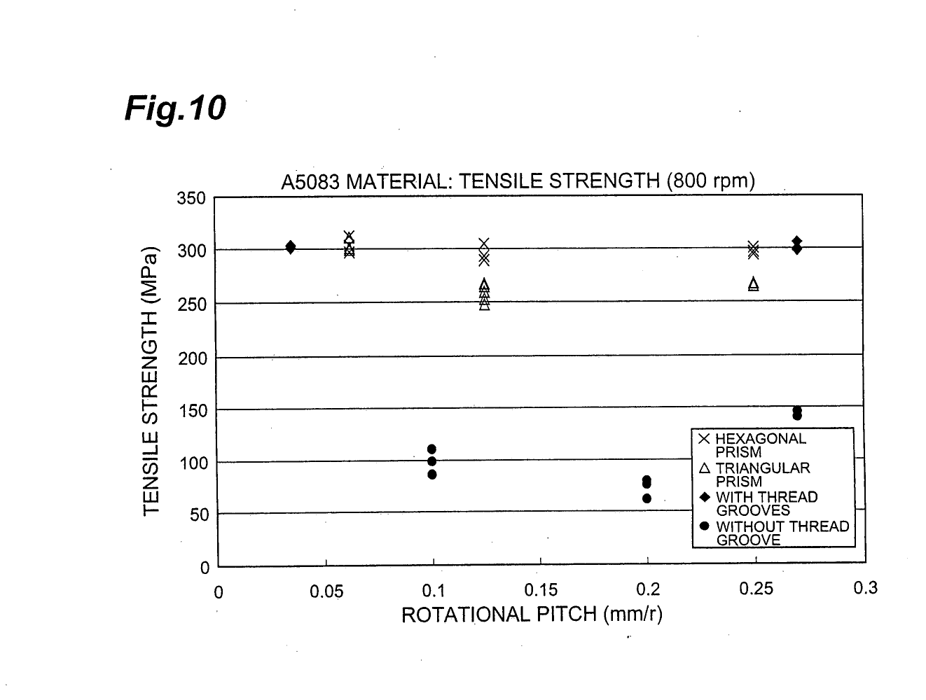

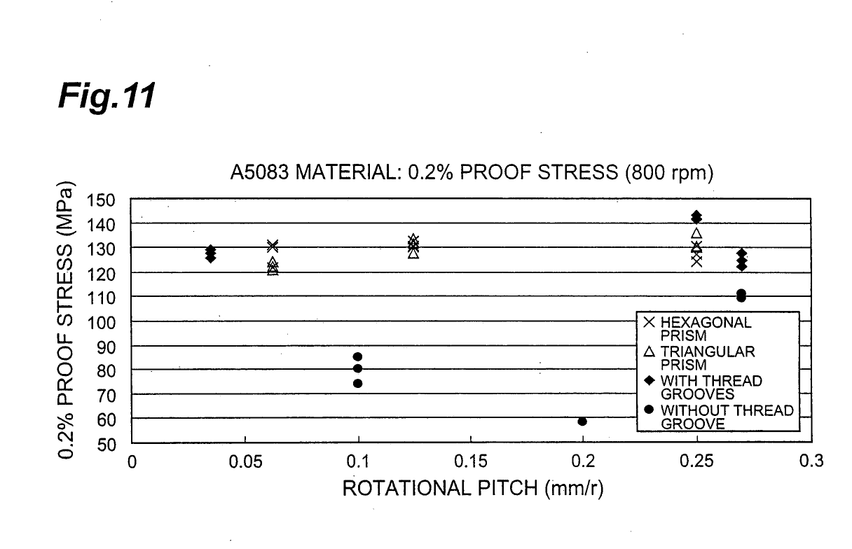

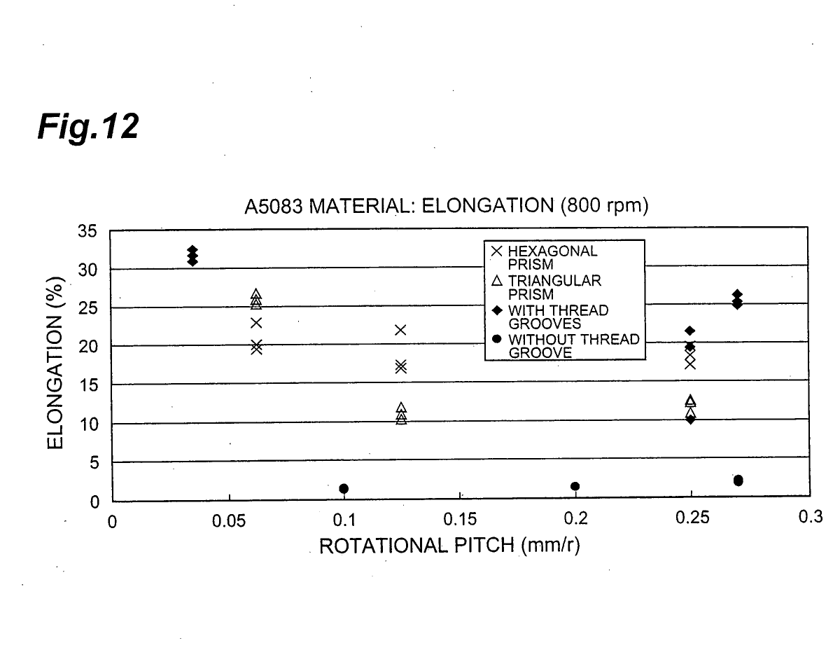

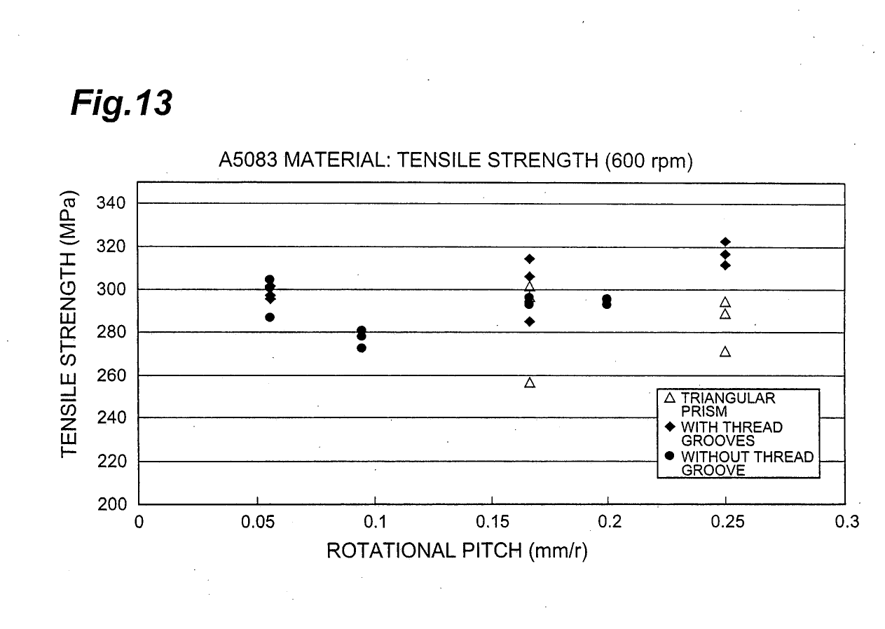

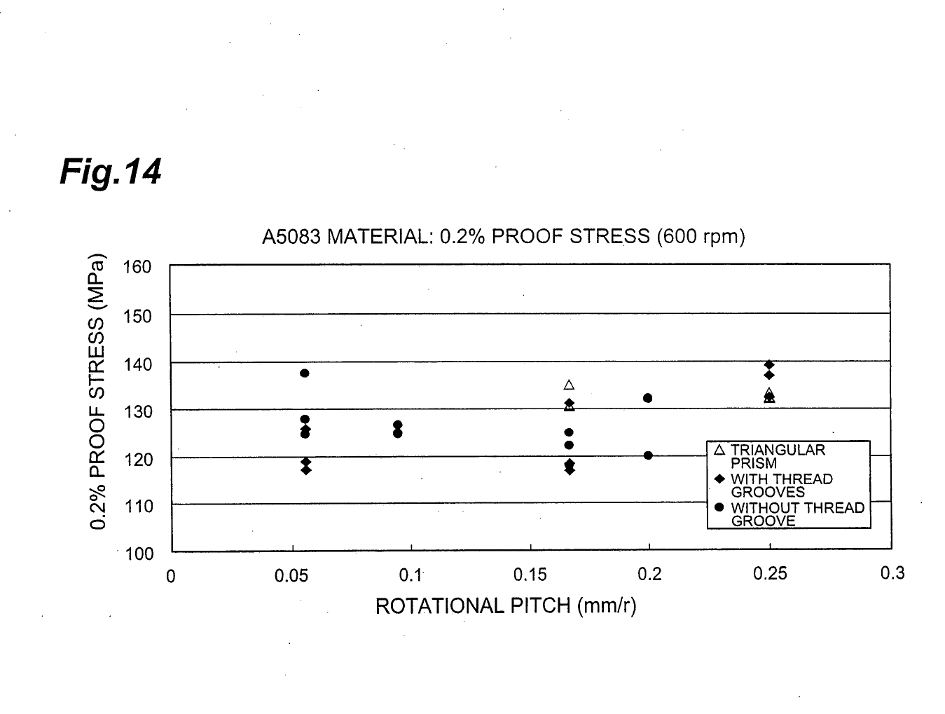

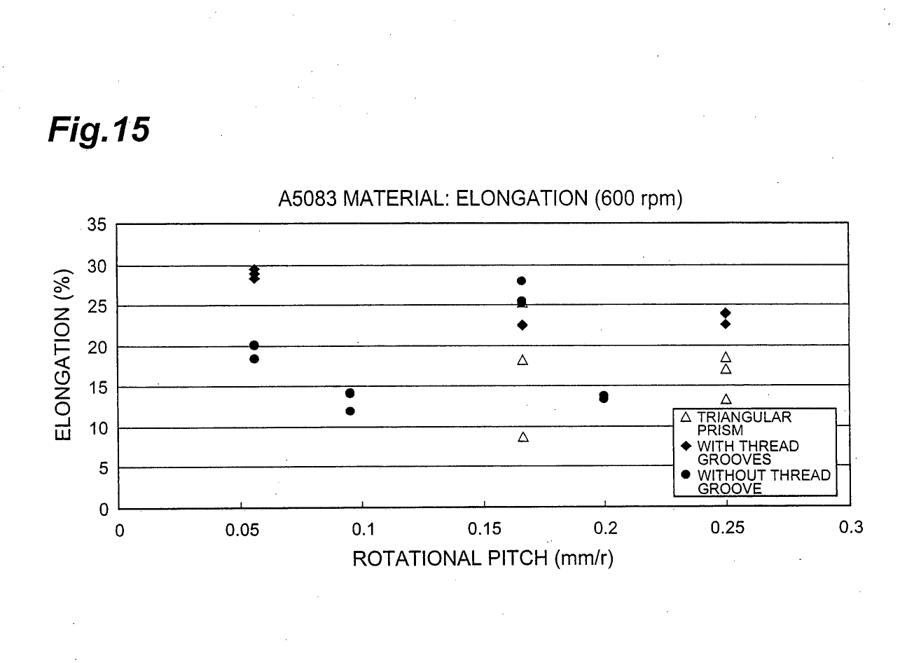

FIG. 10 shows the tensile strength of A5083 materials welded at a rotational speed of 800 rpm. FIG. 11 shows the 0.2% proof stress thereof, and FIG. 12 shows the elongation thereof. FIG. 13 shows the tensile strength of A5083 materials welded at a rotational speed of 600 rpm. FIG. 14 shows the 0.2% proof stress thereof, and FIG. 15 shows the elongation thereof.

As seen in FIGS. 10 to 15, the conventional method using a rotary tool with thread grooves thereon attained welded part of A5083 materials giving a certain level of tensile strength at both rotational speeds of 600 rpm and 800 rpm. That is, the conventional method provides welded part of A5083 materials giving a certain level of tensile strength independent of the rotational speed.

On the other hand, according to the welding method of the first embodiment using a rotary tool with a pin having no thread groove thereon, the welding strength at the welded part decreases compared with that of the conventional method at a rotational speed of 800 rpm. However, according to the welding method of the first embodiment, decrease of the rotational speed to 600 rpm provides welding strength almost equal to that obtained by the conventional method. That welding strength was attained under the condition of rotational pitch in a range from 0.05 [mm/r] to 0.20 [mm/r], inclusive.

Note that, at the respective rotational speeds of 600 rpm and 800 rpm, the welding strength at the welded part of A5083 materials welded by a rotary tool with a pin in a triangular prism shape is equivalent to the welding strength at the welded part of A5083 materials welded by rotary tools with pins in other shapes.

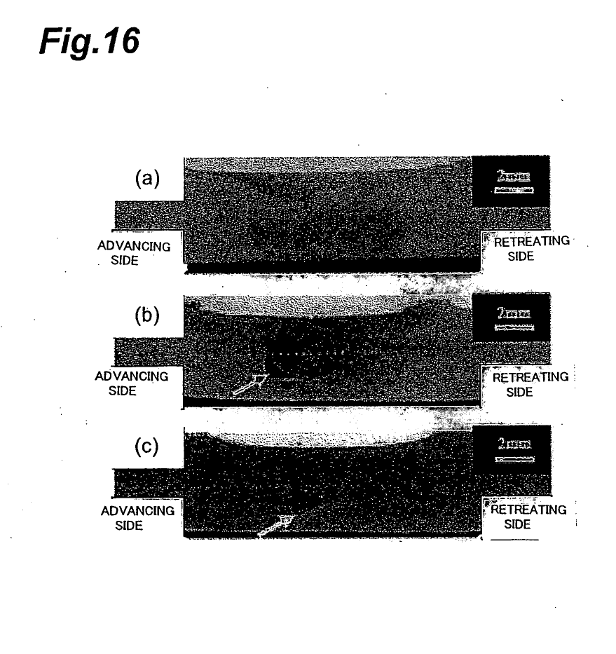

FIG. 16 shows cross sections of welded part of A5083 materials. FIG. 16(a) shows a cross section of welded part obtained by a rotary tool having thread grooves thereon at a rotational speed of 800 rpm, FIG. 16(b) shows a cross section of welded part obtained by a rotary tool having no thread groove thereon at a rotational speed of 800 rpm, and FIG. 16(c) shows a cross section of welded part obtained by a rotary tool having no thread groove thereon at a rotational speed of 600 rpm.

As seen in FIG. 16(a), at a rotational speed of 800 rpm, the rotary tool having thread grooves thereon provides a good welded part. On the other hand, as seen in FIG. 16(b), the rotary tool having no thread groove thereon generates a large tunnel-shaped defect at the advancing side (arrowed position) at a rotational speed of 800 rpm. The welding strength decreases presumably by the defect. At a rotational speed of 600 rpm, however, as shown in FIG. 16(c), the defect becomes very small, which phenomenon is a presumable cause of attaining welding strength similar level to that of the welding by a threaded tool.

Above results revealed that the welding method of the first embodiment performs favorable welding of A5083 materials when the value of {(the rotational speed of the rotary tool [rpm] ×the shoulder diameter [mm]³)/(the moving speed of the rotary tool [mm/min]/the plate thickness [mm]} is in a range from 3.38×10³ to 13.5×10³, inclusive.

As described above, even with a relatively hard and high strength metals such as A5083 material, welding strength equivalent to that of the conventional method can be obtained by decreasing the rotational speed of the rotary tool.

### EXPERIMENTAL EXAMPLE 4

With the rotary tool shown in FIG. 1(b), A2017 materials specified in JIS H 4000 were welded together by the friction stir welding method, illustrated in FIG. 1(a). The A2017 materials used in Experimental Example 4 were plates having a thickness of 5 mm. The rotational speed of the rotary tool was 1500 rpm. The welding speed was varied between 25 and 800 mm/min. The rotary tool had a shoulder diameter of 15 mm, a pin length of 4.7 mm, and a pin diameter of 6 mm. For comparison, A2017 materials were welded together using the conventional method under the same condition.

Here, the A2017 material is an alloy containing Cu, Mg, Mn and the like, and is a non-heat treated alloy called the “duralumin”. Since A2017 material shows high strength and contains a large quantity of Cu, it is poor in corrosion resistance. Accordingly, if the A2017 material is exposed to a corrosive environment, an anticorrosive measures is required. The material has 428 MPa of tensile strength and 319 MPa of 0.2% proof stress.

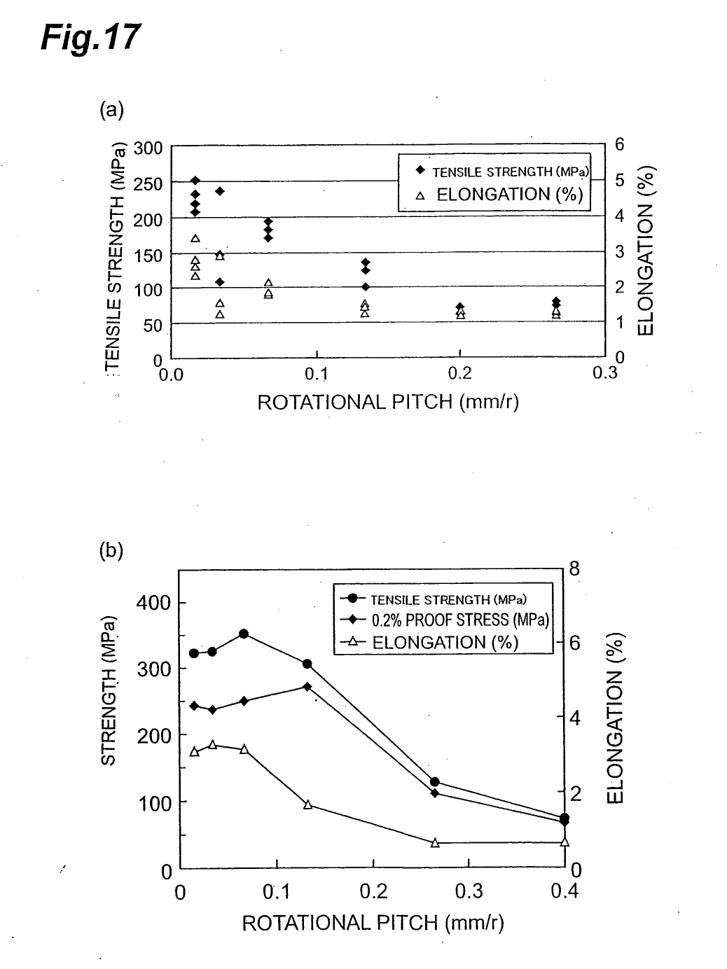

FIG. 17 shows the result of tensile test at the welded part of A2017 materials. FIG. 17(a) shows the result of tensile test at the welded part of A2017 materials obtained by the method of the first embodiment, and FIG. 17(b) shows the result of tensile test at the welded part of A2017 materials obtained by the conventional method. As seen in FIG. 17, compared with the welded part obtained by the conventional method, the welded part of A2017 materials obtained by the method of the first embodiment at rotational pitches from 0.02 to 0.3 [mm/r] showed no improvement in the tensile strength and the elongation.

Also for the A2017 materials, however, it is expected to improve the welding strength by decreasing the rotational speed of the rotary tool as in the case of Experimental Example 3. To this point, to further study the relation between the welding strength and the rotational speed of the rotary tool, the A2017 materials were welded together using the above rotary tool having thread grooves thereon and a rotary tool having no thread groove thereon. The rotational speed of the rotary tool was 600 rpm, and the welding speed was varied in a range from 25 to 300 mm/min, thus compared the welding strength with that in above case of welding at 1500 rpm of rotational speed.

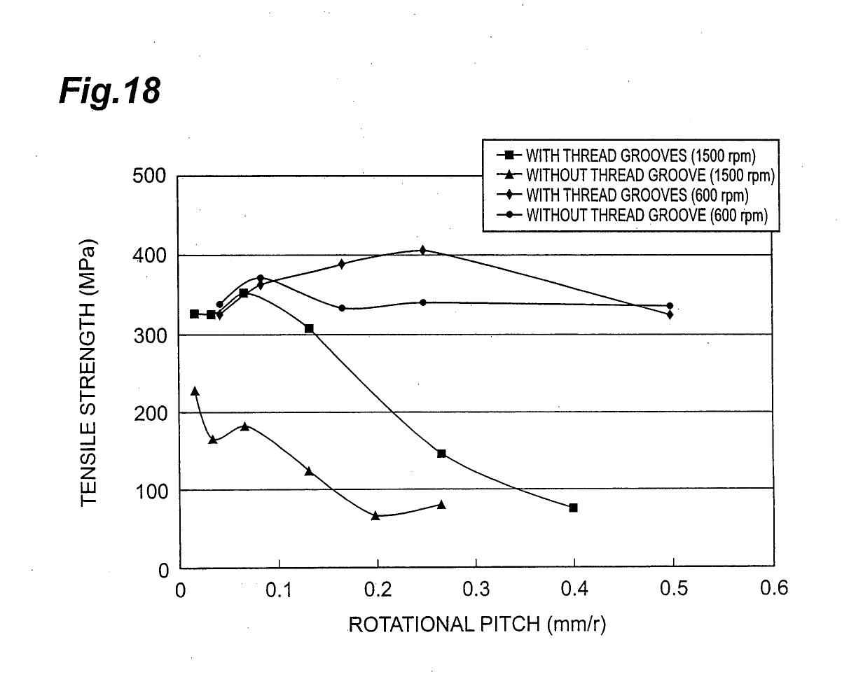

FIG. 18 shows the result of tensile test at the welded part of A2017 materials, using the rotary tool with thread grooves and the rotary tool without thread groove, varying the rotational speed thereeach. For comparison, FIG. 18 also shows the result of above welding at a rotational speed of 1500 rpm.

With the reference of FIG. 18, it is found that both the conventional method using a rotary tool with thread grooves and the welding method of the first embodiment using a rotary tool without thread groove decrease the tensile strength at the welded part with the increase in the rotational pitch (welding speed) at a rotational speed of 1500 rpm.

On the other hand, according to the welding method of the first embodiment, it was found that, at the rotational speed of 600 rpm, both the rotational pitches (welding speeds) give a welded part of A2017 materials having tensile strength similar to that of the welded part obtained by a rotary tool with thread grooves thereon at a rotational speed of 600 rpm. The result was derived at the rotational pitches in a range from 0.04 to 0.50 [nm/r], inclusive.

The above results show that, even in welding the A2017 materials by a rotary tool without thread groove, the welding strength at the welded part of the A2017 martial becomes equivalent to that obtained by the conventional method, by welding the materials at rotational speeds of 600 rpm or smaller. In addition, it is expected that a high strength material such as A2024 material and A7075 material can improve the welding strength by decreasing the rotational speed of the rotary tool.

From the above results, it was found that the welding method of the first embodiment favorably welds the A2017 materials when the value of {(the rotational speed of the rotary tool [rpm]×the shoulder diameter [mm]³)/the moving speed of the rotary tool [mm/min]/the plate thickness [mm]} is in a range from 1.35×10³ to 16.9×10³, inclusive.

By summarizing the results of Experimental Examples 1 to 4, it was concluded that the welding of Al having relatively mild and small-strength, giving 0.2% proof stress of 200 MPs or less, preferably 150 MPa or less, and more preferably 70 MPa or less, by the method of the first embodiment provides a welded part having higher welding strength than that of the conventional method.

In addition, in the welding method of the first embodiment, to improve the welding strength at the welded part of metals which have relatively hard and strong strength, as in the cases of Experimental Examples 2 to 4, two methods may be applied.

The one is the method to decrease the welding speed. As shown in FIG. 9 and FIG. 17(a), the tensile strength at the welded part obtained by the welding method of the first embodiment increases with decrease in the welding speed at a constant rotational speed. In this case, for example, at a rotational speed of 1500 rpm, the welding speed is preferably 200 mm/min or smaller, more preferably 100 mm/min or less, and most preferably 25 mm/min or smaller.

The other method for improving the welding strength is the one to decrease the rotational speed of the rotary tool. By decreasing the rotational speed, the pin having no thread groove thereon makes the metal being easily stirred. As a result, even a metal of hard and high strength can increase the welding strength at the welded part. For example, by adjusting the rotational speed of the rotary tool to 600 rpm or less, the welding strength at the welded part of A5083 materials and of A2017 materials improves.

Above two methods are effective for the case of welding metals of relatively hard and strong, giving less than 320 MPa of 0.2% proof stress at the friction stir welded part, and more preferably 200 MPa or smaller thereof.

### EXPERIMENTAL EXAMPLE 5

With the rotary tool shown in FIG. 1(b), A6061 materials specified in JIS H 4000 were welded together by the friction stir welding method, illustrated in FIG. 1(a). The A6061 materials used in Experimental Example 5 were plates having a thickness of 5 mm. The rotational speed of the rotary tool was 1500 rpm. The welding speed was varied between 100 and 1000 min/min. The rotary tool had a shoulder diameter of 15 mm, a pin length of 4.7 mm, and a pin diameter of 6 mm.

Separately, a rotary tool with a pin in a regular-triangular prism shape, shown in FIG. 2, and a rotary tool with a pin in a regular-hexagonal prism shape, shown in FIG. 3, were used to weld the A6061 materials, respectively, under the same condition to above.

Further, for comparison, a conventional rotary tool with a pin having thread grooves thereon, (refer to FIG. 4), was used to weld the A6061 materials under the same condition.

Here, the A6061 material is an alloy containing Mg, Si, Fe, and Cu, giving excellent strength and corrosion resistance. The tensile strength thereof is 309 MPa, and the 0.2% proof stress is 278 MPa.

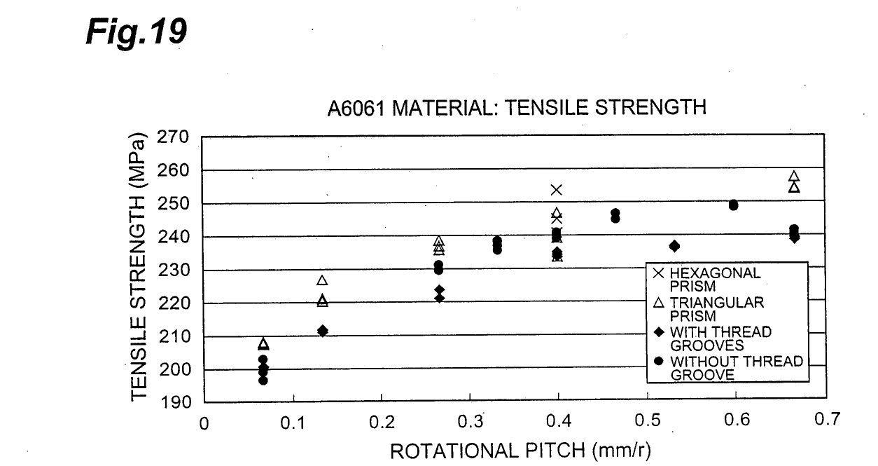

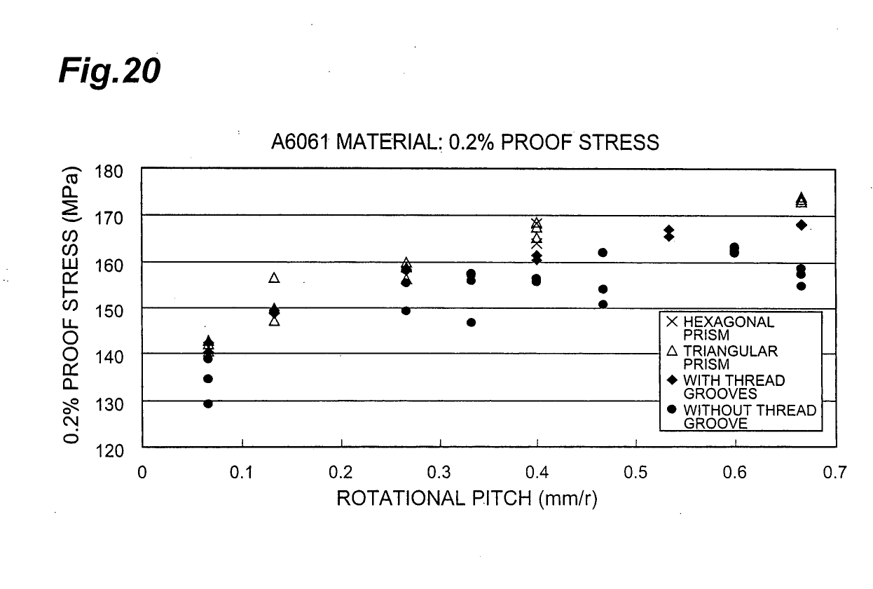

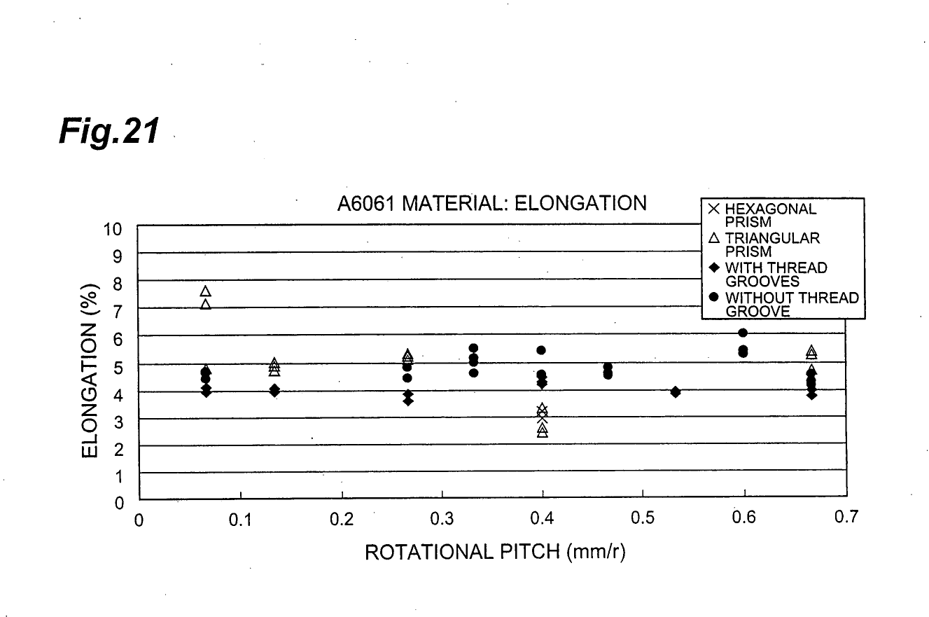

FIG. 19 shows the tensile strength of the welded A6061 materials, FIG. 20 shows the 0.2% proof stress thereof, and FIG. 21 shows the elongation thereof.

As seen in FIGS. 19 to 21, the welding method of the first embodiment provided welding strength and elongation at the welded part of A6061 materials equivalent to those at the welded part obtained by applying a rotary tool with thread grooves of the conventional method at rotational pitches in a range from 0.07 to 0.67 [mm/r].

From FIGS. 19 to 21, it was found that the welding method of the first embodiment favorably welds the A6061 materials at the rotational pitches of 0.2 [mm/r] or larger. Therefore, according to the welding method of the first embodiment, the A6061 materials are favorably welded together when the value of {(the rotational speed of the rotary tool [rpm]×the shoulder diameter [mm]³)/the moving speed of the rotary tool [mm/min]/the plate thickness [mm]} is 3.38×10³ or larger.

The above results revealed that even in the case of welding metals having hardness and strength of A6061 materials, the welding method of the first embodiment provides a welded part having higher strength than that attained by the conventional method. Generally the A6061 material has a tensile strength of 309 MPa, and is relatively hard giving the 0.2% proof stress of 278 MPa, and is a strong material. If, however, at 370° C. of friction stir welding temperature, the 0.2% proof stress of the A6061 material decreases to about 13 MPa. The level of the proof stress is similar level to that of A1050 material at 370° C. The phenomenon presumably increases the strength at the welded part similar to the case of A1050 material in Experimental Example 1.

### EXPERIMENTAL EXAMPLE 6

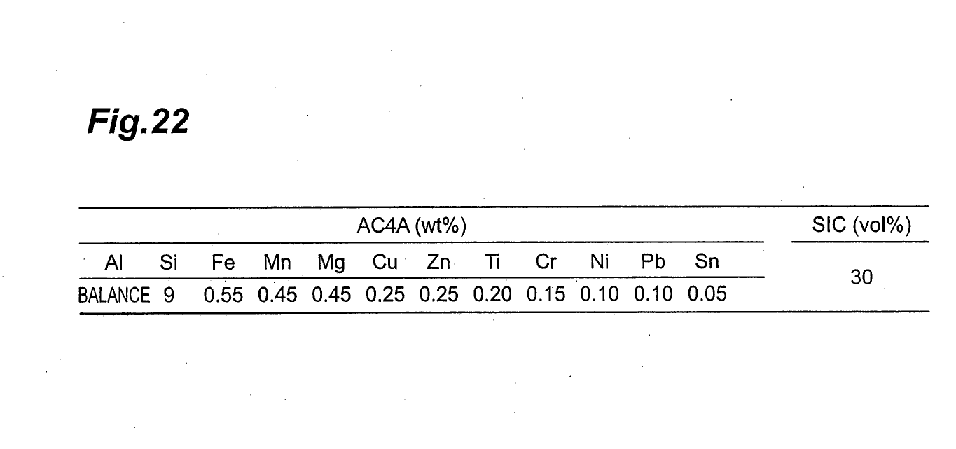

With a conventional rotary tool with a pin having thread grooves thereon and a rotary tool with a pin having no thread groove thereon, shown in FIG. 1(b), the welding of composite materials of AC4A material impregnated with SiC in an amount of 30% by volume was conducted using the method illustrated in FIG. 1(a). The detail of the composition of the composite material is shown in FIG. 22. The experiment welded two sheets of plate-shape composite materials, each having 5 mm in thickness.

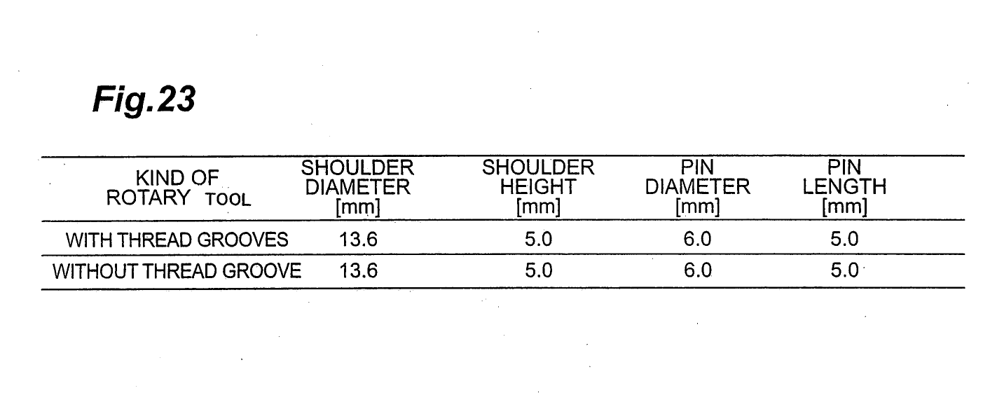

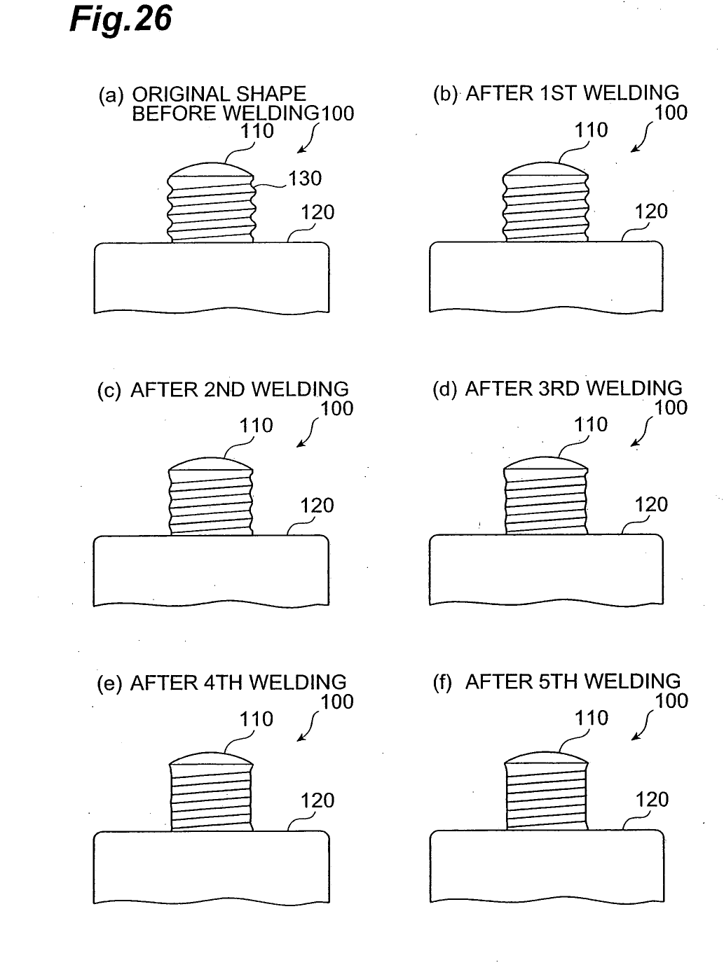

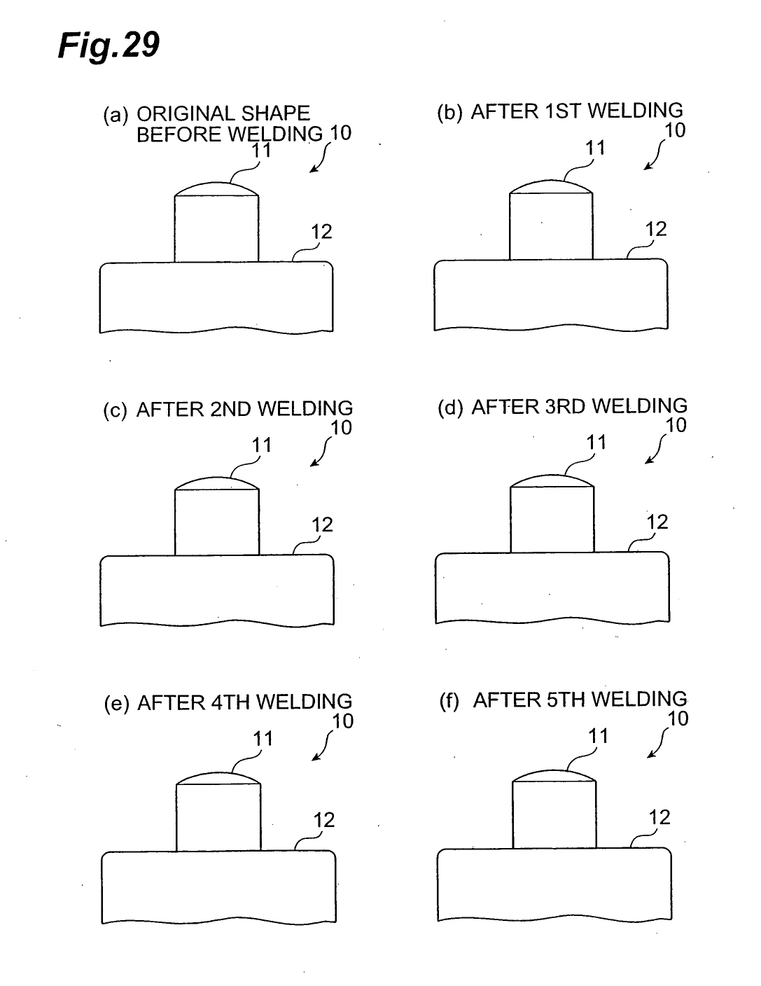

The applied rotary tool having thread grooves is a rotary tool 100 shown in FIG. 26(a), which had the pin 110 and a shoulder 120, while a pin 110 had thread grooves 130 on the side face thereof. As the rotary tool without thread groove was a rotary tool 10 shown in FIG. 29(a), which had a pin 11 and a shoulder 12, while the side of the pin 11 gave a smooth curved surface. The size of each rotary tool is given in FIG. 23. For the shoulder height of FIG. 23, the shoulder height was assumed as equal to the height of the pin, for convenience of calculation. Each rotary tool was made of a WC—Co hard metal.

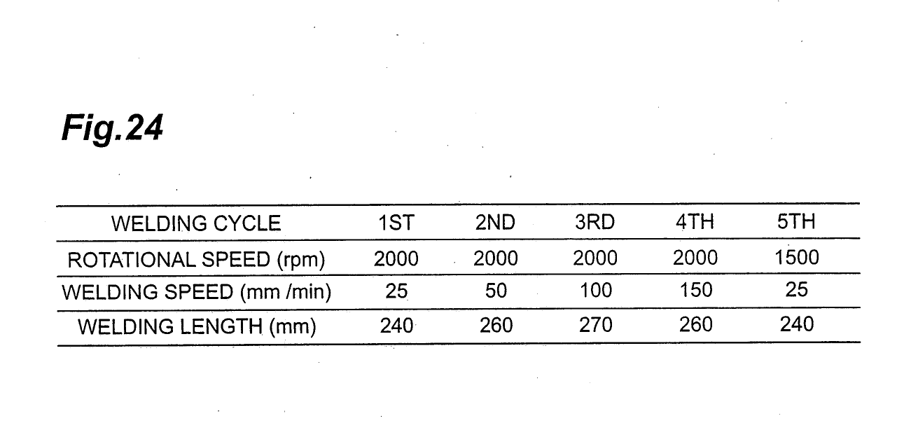

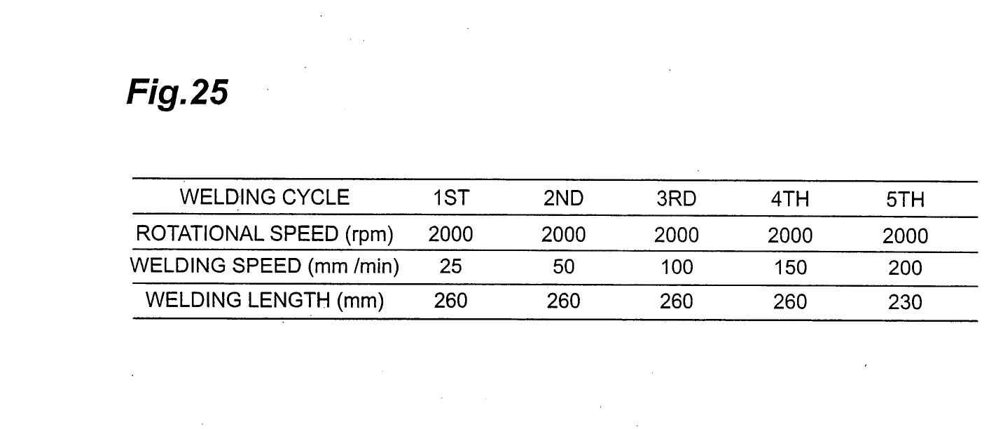

With the above rotary tool having thread grooves, five times of welding of the composite materials were given under the welding condition shown in FIG. 24. Furthermore, five times of welding of the composite materials were given using the above rotary tool without thread groove under the condition given in FIG. 25.

FIG. 26 shows the changes in appearance of the rotary tool having thread grooves in Experimental Example 6. FIGS. 26(a) to 26(f) show the appearance of rotary tool having thread grooves before the welding and after each time of welding, respectively, in Experimental Example 6.

Referring to FIG. 26, the following was found. That is, although thread grooves 13 on the rotary tool in the original state, or before welding, showed normal appearance, (refer to FIG. 26(a)), the thread peaks are gradually worn on every welding cycle, (refer to FIGS. 26(b) to 26(e)), and after the welding on fifth time, the thread peaks were completely worn out to become flat side surface, (refer to FIG. 26(f)). That type of wear is presumably caused by a metal flow around the axial line extending in the same direction as the direction crossing the pin-center axis, observed at peripheral area of the pin side face at the thread-groove part.

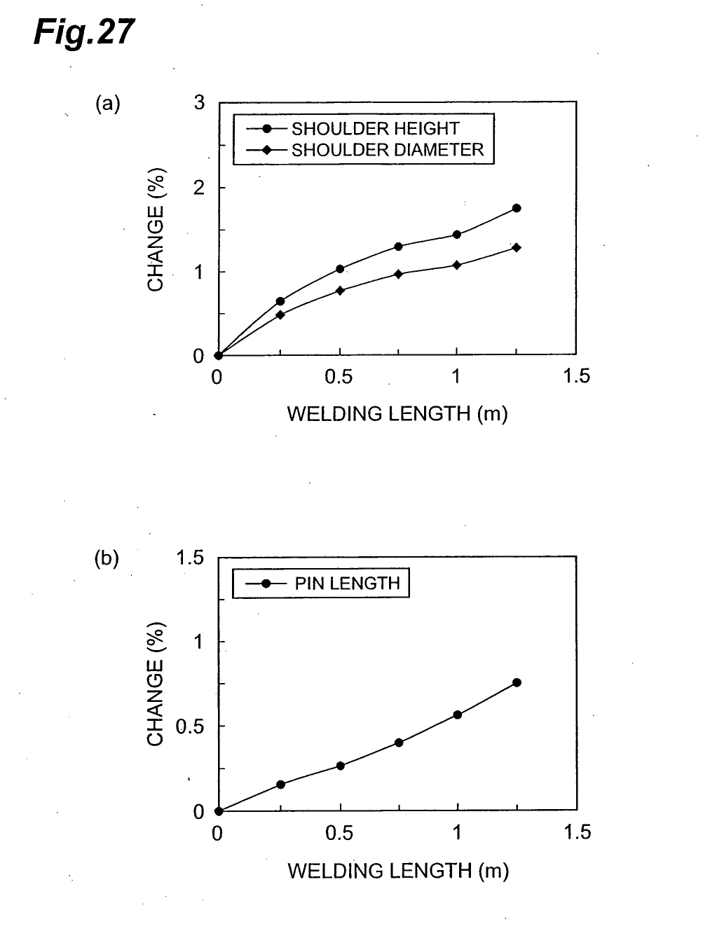

FIG. 27 is the graphs showing the variations of rotary tool with thread grooves, in Experimental Example 6. FIG. 27(a) shows the size changes of the shoulder of the rotary tool with thread grooves, in Experimental Example 6, while FIG. 27(b) shows the changes in length of the pin. FIG. 27 shows that the changes in the shoulder size and the pin length of the rotary tool are very small.

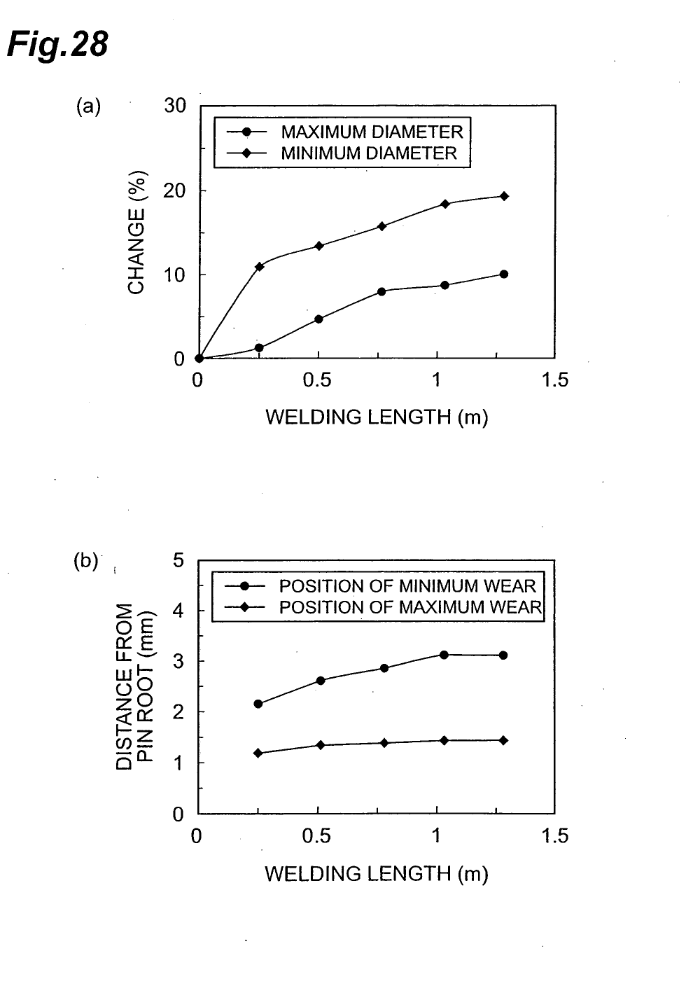

FIG. 28 is the graphs showing the changes of the rotary tools with thread grooves, in Experiment Example 6. FIG. 28(a) shows the changes in the pin diameter of the rotary tool with thread grooves, in Experimental Example 6. FIG. 28(b) shows the changes in the worn part. As seen in FIG. 28(a), the wear of pin in the diametric direction is very large compared with the wear in the longitudinal direction. As shown in FIG. 28(b), the position of smallest wear becomes apart from the root of the pin with the progress of welding cycles, and the position comes close to a position of 3.2 mm from the root. On the other hand, with increase in the number of welding cycles, the position of largest wear becomes 1.5 mm from the root of the pin.

FIG. 29 illustrates the changes in appearance of rotary tool without thread groove, in Experimental Example 6. FIGS. 29(a) to 29(f) show the appearance of the rotary tool without thread groove, giving the original appearance before welding, and the appearances after every welding cycle, in Experimental Example 6. FIG. 29 revealed that the rotary tool without thread groove showed very little changes in the shape of the rotary tool 10 even after progressing of the welding cycles.

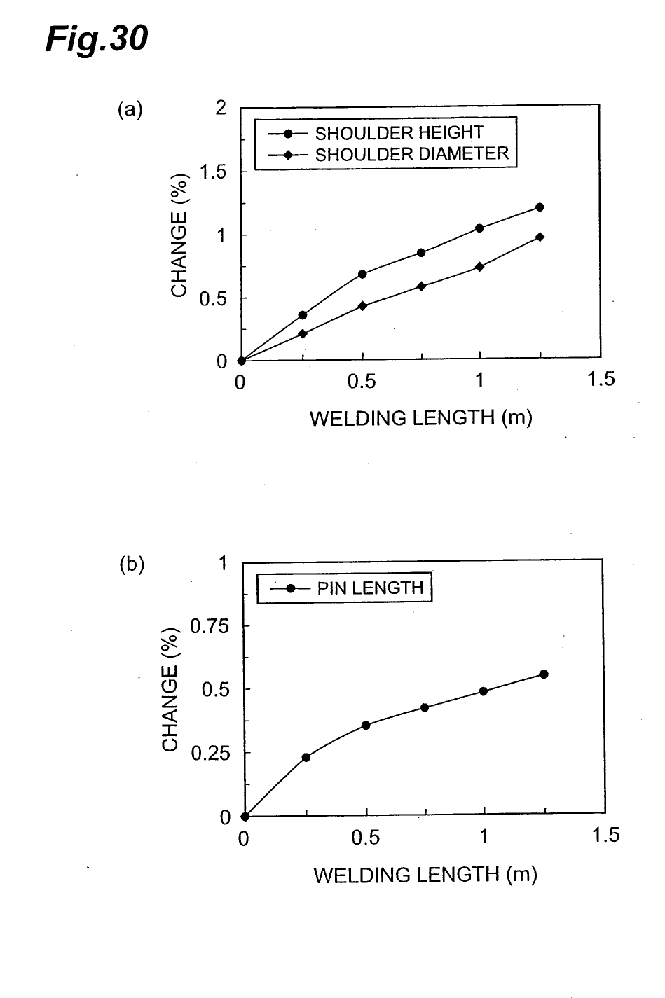

FIG. 30 is the graphs showing the changes of the rotary tools without thread groove, in Experiment Example 6. FIG. 30(a) shows the changes in the shoulder size or the rotary tool having no thread grove, in Experimental Example 6, and FIG. 30(b) shows the changes in pin length. As seen in FIG. 30, the changes in the shoulder size and the pin length of the rotary tool are very small even with the rotary without thread groove.

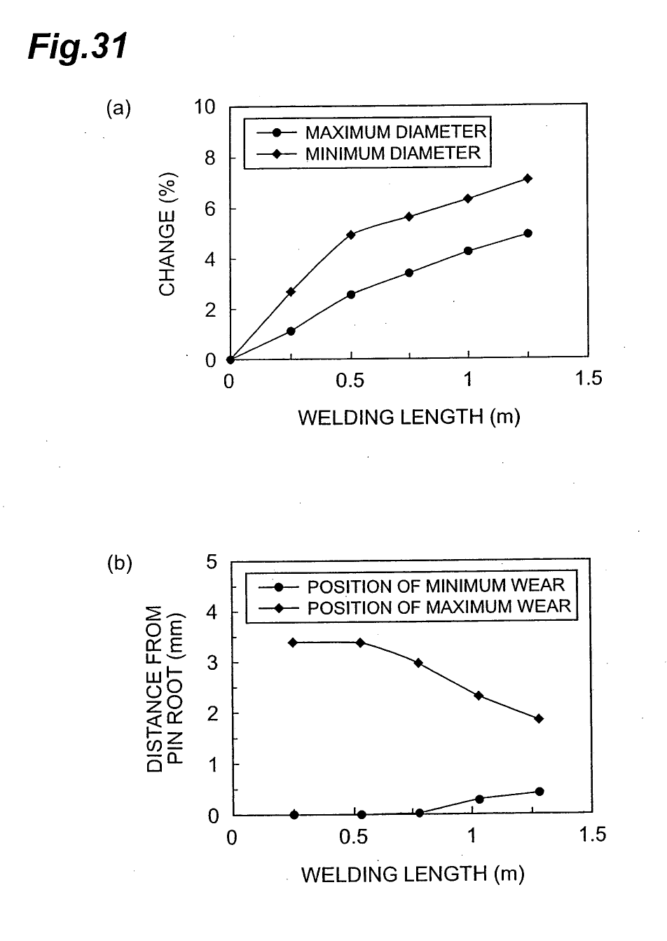

FIG. 31 is the graphs showing the changes in the rotary tool without thread groove, in Experimental Example 6. FIG. 31(a) shows the changes in the pin diameter of the rotary tool without thread groove, in Experimental Example 6, while FIG. 31(b) shows the changes at the worn part. As seen in FIG. 31(a), the changes in the pin diameter of the rotary tool without thread groove is extremely small compared with the changes in the pin diameter of the rotary tool with thread grooves. FIG. 31(b) shows that, inversely from the rotary tool with thread grooves, the rotary tool without thread groove brings the position of the maximum wear distant from the root of the pin, and also the position of minimum wear comes close to the root of the pin, inversely from the case of the rotary tool with thread grooves.

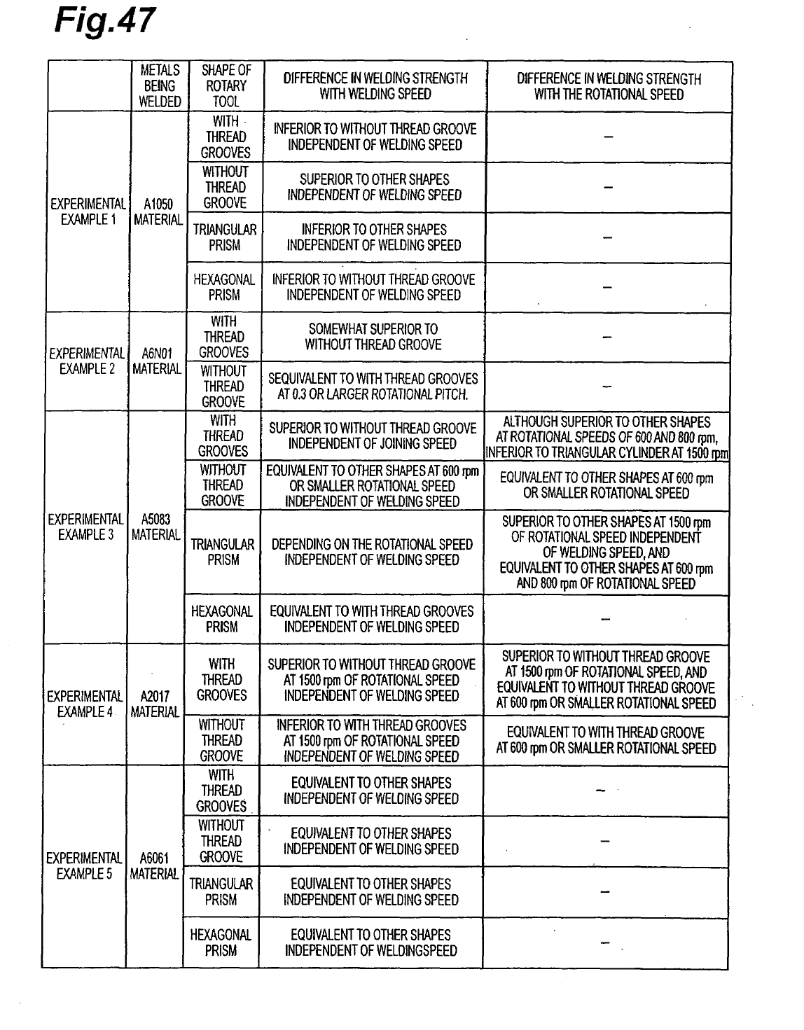

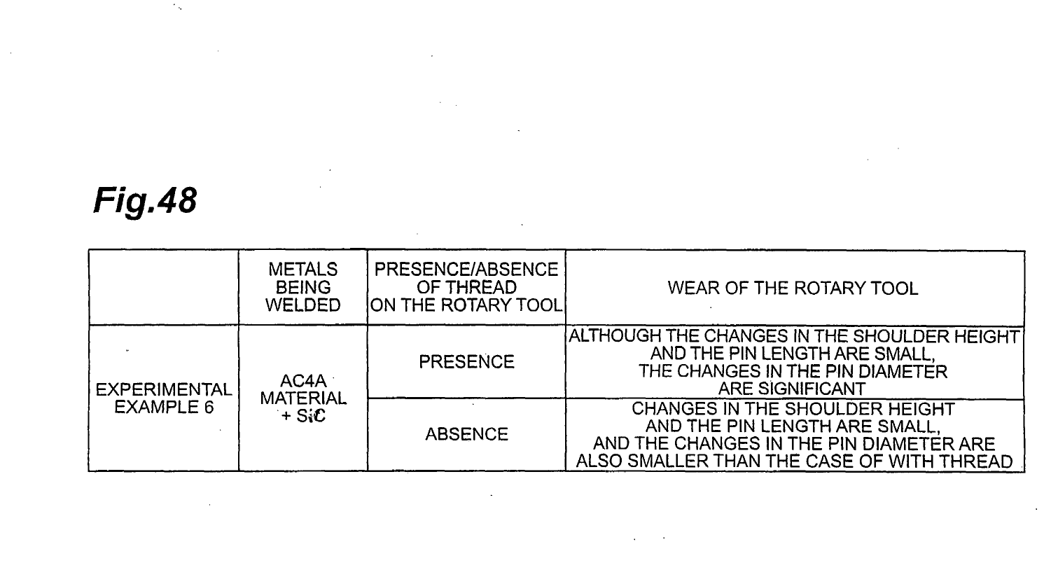

The results of Experimental Examples 1 to 6 are summarized in FIG. 47 and FIG. 48 as a comparative table.

The above Experimental Examples 1 to 6 are described focusing on the case of welding Al materials. The welding method according to the first embodiment is, however, effective also to the case of, for example, welding Fe and stainless steels. For example, the welding method of the embodiment is applicable to the case of welding IF steels used for automobiles and the like. Conventionally, friction stir welding of these metals applied rotary tools made of ceramics or high melting point metals such as W, with a pin in a polygonal prism shape or with a pin having thread grooves thereon. Those types of rotary tools have, however, drawbacks of short life and of difficulty in manufacturing the rotary tool. On the other hand, the rotary tool used in the first embodiment is in a cylindrical shape has no thread groove on the side face thereof, and is not needed to form into a polygonal prism shape. Therefore, the life of the rotary tool prolongs, and the manufacture of the rotary tool becomes easy. For example, to weld metals such as Fe, Ti, and Ni, the welding method of the first embodiment can adopt a rotary tool with a pin having no thread groove thereon of the embodiment, made of hard metal such as tungsten carbide, ceramics such as Si₃N₄, and the like. By conducting the welding of metallic members while applying shield gas such as Ar gas to prevent oxidation of the rotary tool, the welding of long range and long time is available while maintaining the strength and toughness of the tool.

### Second Embodiment

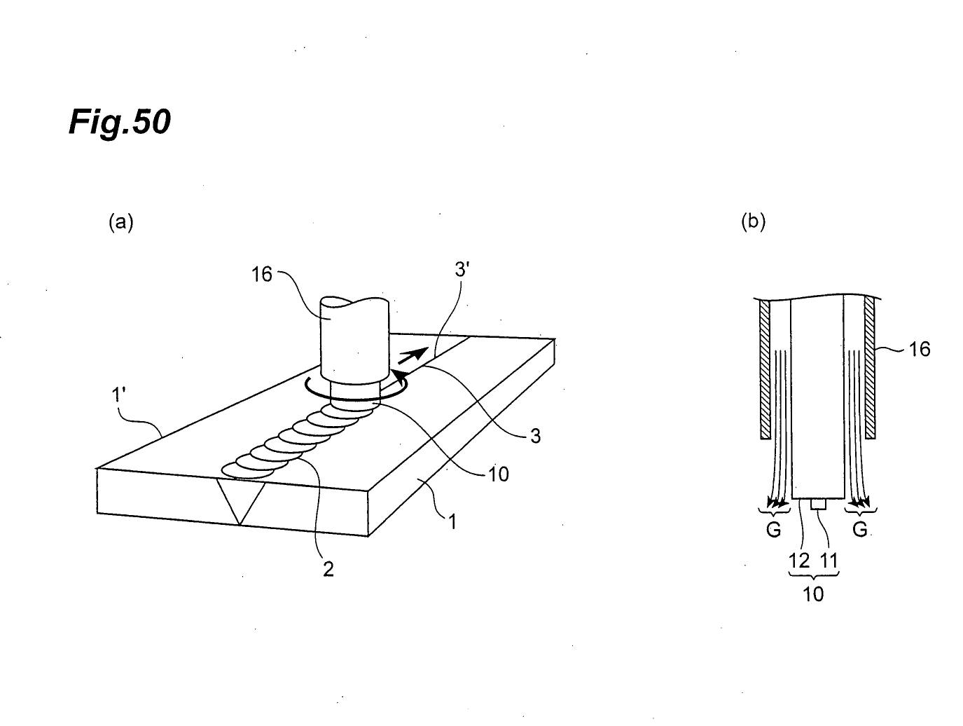

FIG. 50 illustrates the method for welding metals relating to a second embodiment of the present invention. FIG. 50(a) illustrates the friction stir welding according to the method for welding the metals relating to the second embodiment of the present invention, and FIG. 50(b) shows a side view of the rotary tool used for the method for welding metals relating to the second embodiment of the present invention. FIG. 50(b) also shows a cross section of the nozzle.

The method for welding metals of the second embodiment of the present invention is based on the friction stir welding method, and is a suitable welding method for stainless steels. The following description gives the welding method illustrated in FIG. 50, focusing on the points different from the welding method shown in FIG. 1.

The welding method shown in FIG. 50 uses a rotary tool 10 made of a material containing Si₃N₄, which is illustrated in FIG. 50(b). The rotary tool 10 is also structured by a wide shoulder 12 and a thin pin 11 which is formed at the front end of the shoulder 12 and is inserted between edges of the metallic members. The pin 11 is in a right-cylindrical shape, and the side of the pin 11 forms a smooth curved face having no thread groove thereon. The shoulder 12 is in a cylindrical shape having larger diameter than that of the pin 11, and extends in the axial direction of the pin 11. The pin 11 is formed at the front end of the shoulder 12, or at one end of the shoulder 12.

The rotary tool 10 shown in FIG. 50(b) preferably contains a binder, other than Si₃N₄. By adding the binder to the rotary tool 10, crack generation on the rotary tool 10 is suppressed. For example, the rotary tool 10 contains Si₃N₄ in an amount of 90% by weight, and balance of Al₂O₃ and Y₂O₃ as the binder. In that case, the hardness (HRA) of the rotary tool 10 is 92 (Rockwell hardness of 120° under a test load of 60 kg by a diamond cone indenter).

In addition, as shown in FIG. 50, the welding method preferably uses a nozzle 16 located to cover the side faces of the rotary tool 10 so as to supply a gas G containing Ar from the nozzle 16. The gas containing Ar cools the rotary tool while preventing the hardening of the stainless steel material, and thereby suppressing the crack generation on the rotary tool 10.

### EXPERIMENTAL EXAMPLE 7

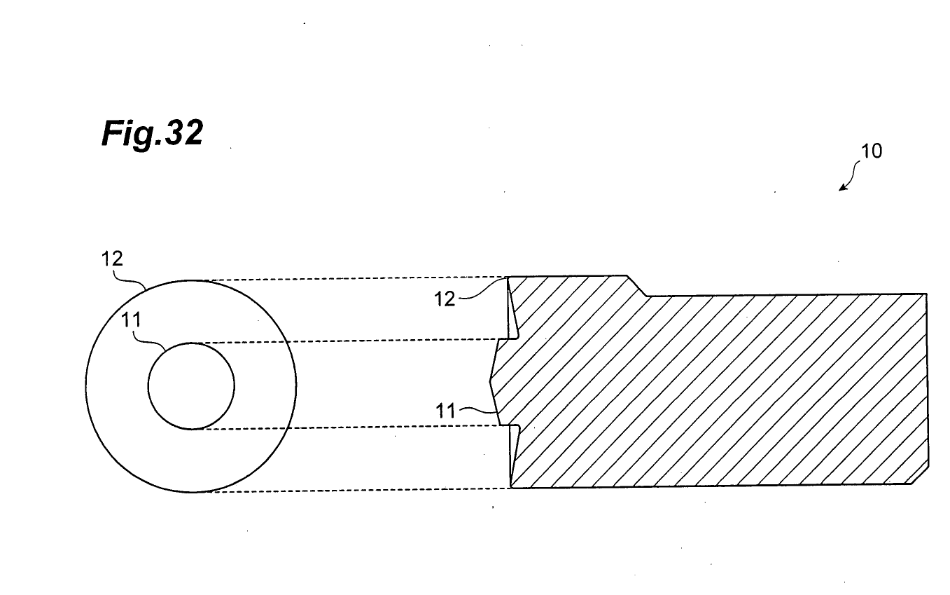

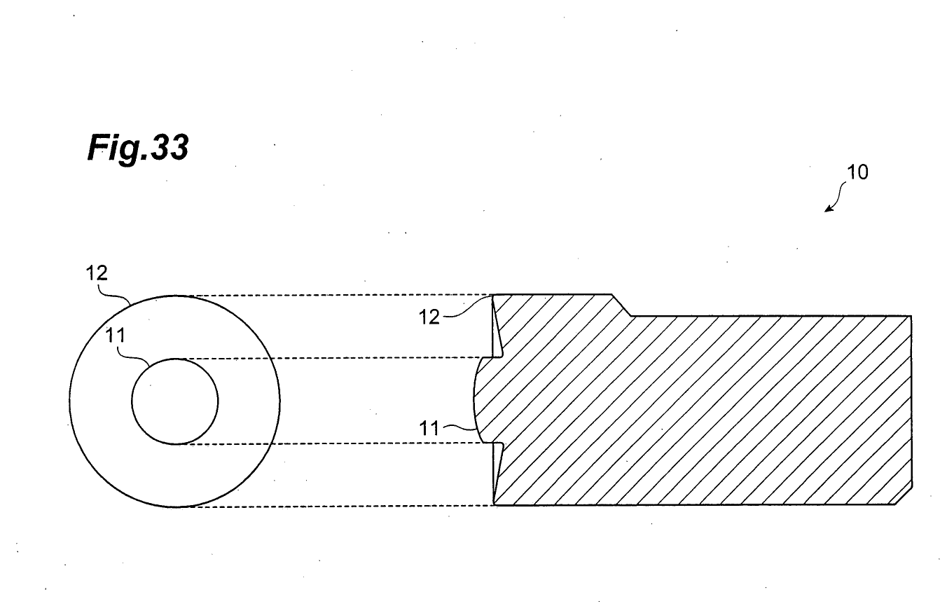

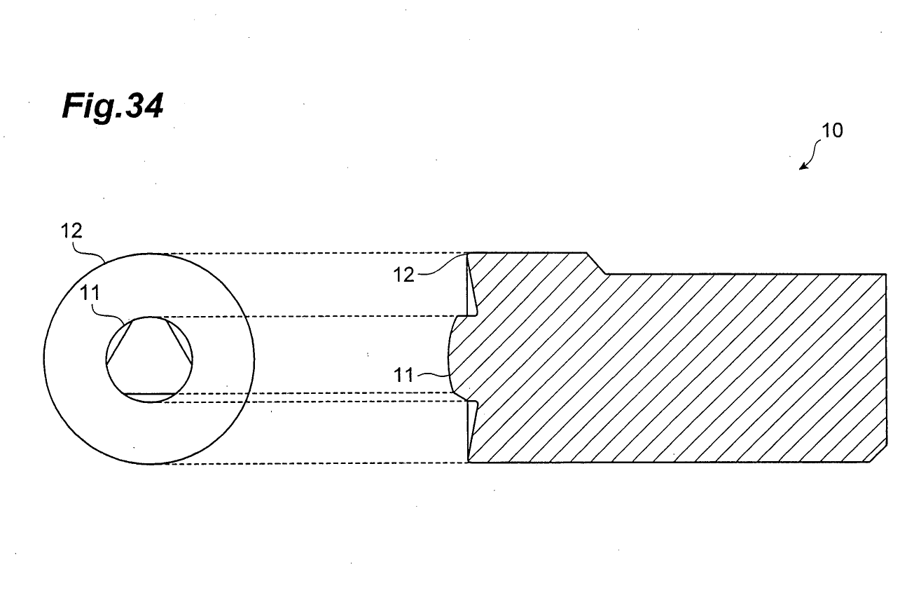

To investigate the relation between the shape of the rotary tool and the welding strength at the welded part of the stainless steels, there was given the welding of SUS304 material specified in JIS G 4305 and SUS301L-DLT material specified by JIS E 4049 using the method illustrated in FIG. 50(a) with a rotary tool with a pin having a top in a conical shape, (refer to FIG. 32), a rotary tool with a pin having a top in a spherical shape, (refer to FIG. 33), and a rotary tool with a pin in a polygonal prism shape, (refer to FIG. 34), respectively. The plate thickness of SUS304 and SUS301L-DLT was 1.5 mm.

The rotary tool 10 shown in FIG. 32 has the pin 11 in a cylindrical shape at the front end thereof. The diameter of the pin 11 is 5 mm, and the diameter of the shoulder 12 is 15 mm. The pin 11 protrudes from the shoulder 12 by 1.4 mm, and a portion of 0.7 mm from the top of the pin 11 is formed in a conical shape as shown in FIG. 32.

The rotary tool 10 shown in FIG. 33 has the pin 11 in a cylindrical shape at the front end thereof. The diameter of the pin 11 is 5 mm, and the diameter of the shoulder 12 is 15 mm. The pin 11 protrudes from the shoulder 12 by 1.4 mm, and the top of the pin 11 is formed in a spherical shape having SR 5.4.

The rotary tool 10 shown in FIG. 34 has the pin 11 in a polygonal prism shape at the front end thereof. The diameter of the pin 11 is 6 mm, and the diameter of the shoulder 12 is 15 mm. The pin 11 protrudes from the shoulder 12 by 1.4 mm. As illustrated in FIG. 34, the pin 11 is chamfered at three positions on the side face of the cylinder to form approximately polygonal prism shape.

The rotary tools given in FIGS. 32 to 34 have a composition of Si₃N₄ in an amount of 90% and balance of Al₂O₃ and Y₂O₃. In Experimental Example 7, there were given the tensile test at the welded part and the elongation test thereat using the same sample for each rotary tool.

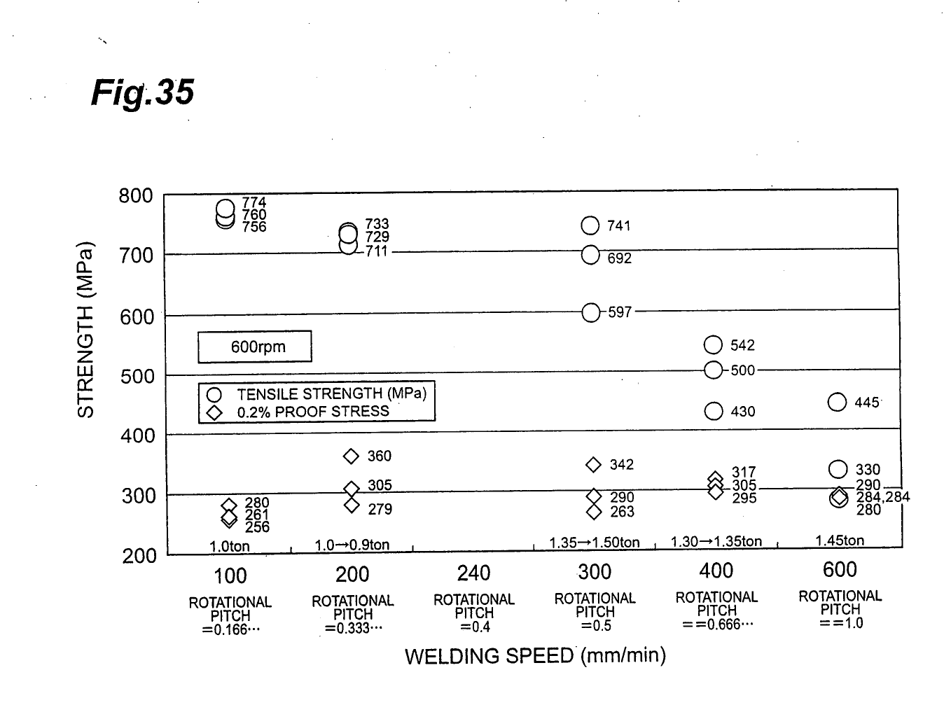

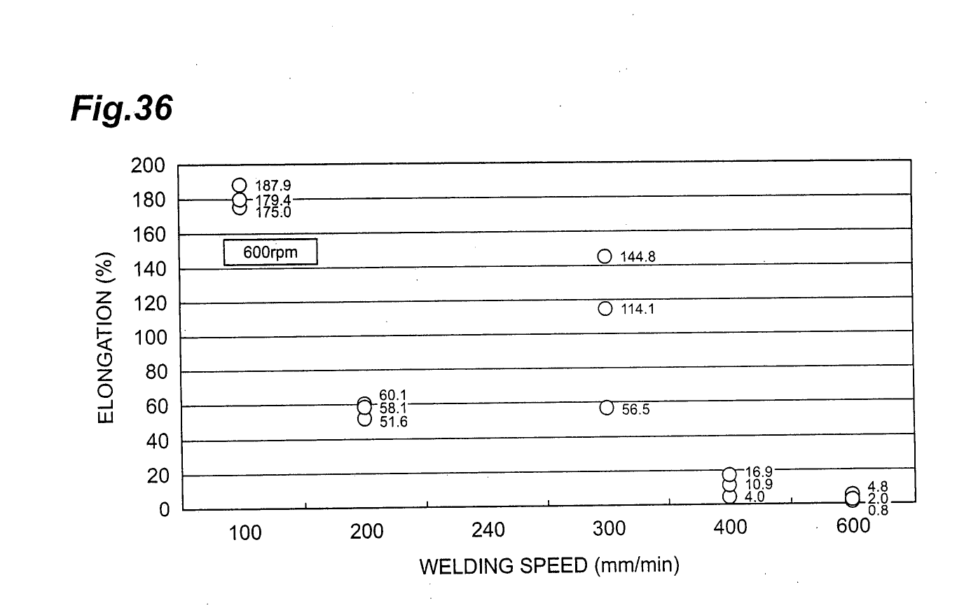

FIG. 35 shows the result of tensile test at the welded part of SUS304 materials welded by the rotary tool with a pin having a top in a conical shape. FIG. 36 shows the result of elongation test at the welded part of SUS304 materials welded by the rotary tool with a pin having a top in a conical shape. In FIGS. 35, 37, 39, 41, 42, and 44, the terms “1.0 ton”, “1.0→0.9 ton”, and the like given on the horizontal axis designate the respective compression forces of the rotary tool against the mother material.

FIG. 35 shows that the welding method of the second embodiment gives almost good welding strength at welded part of SUS304 materials under the condition of 300 mm/min or smaller welding speed, 600 rpm of rotational speed, and 0.5 or smaller rotational pitch. As seen in FIG. 36, an adequate value of the elongation was attained at welded part of SUS304 materials under the condition of 300 mm/min or smaller welding speed, 600 rpm of rotational speed, and 0.5 or smaller rotational pitch.

The good welded part of SUS304 materials obtained under the condition of 300 mm/min or smaller welding speed and 0.5 or smaller rotational pitch comes from hardly-generating defects at the welded part. That is, under that welding condition, the heat entering the metallic members (SUS304 materials) is large, and the plastic flow of the metals is sufficient so that the good welding is attained. It is known that the heat entering a metal is proportional to the rotational speed of the rotary tool and the cube of the shoulder diameter of the rotary tool, while inversely proportional to the welding speed. Considering the known relation, when the SUS304 materials are welded together using a rotary tool with a pin having a top in a conical shape, it is expected to obtain almost good welding strength at the welded part of SUS304 materials if only the value of {(the rotational speed of the rotary tool [rpm] ×the shoulder diameter [mm]³)/the moving speed of the rotary tool [min/min]/the plate thickness [mm]} is 4.5×10³ or larger.

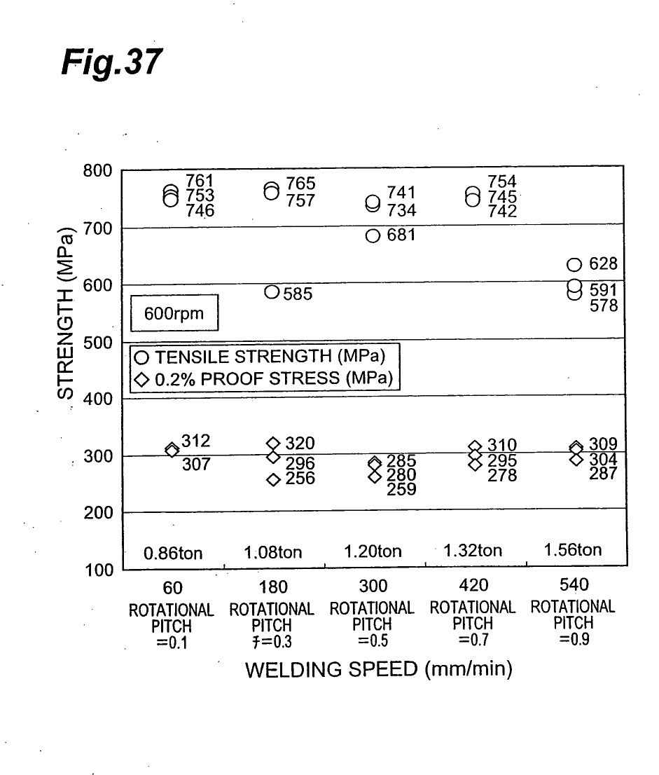

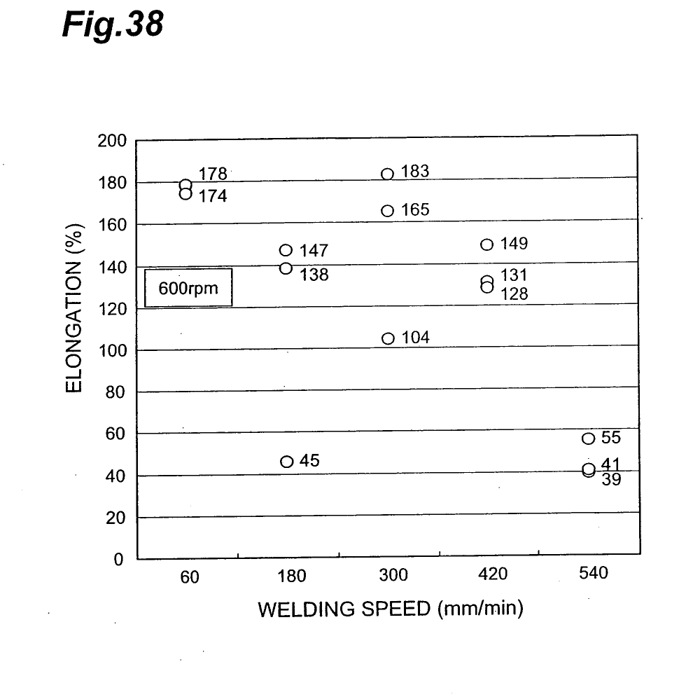

FIG. 37 shows the result of tensile test at the welded part of SUS304 materials, using the rotary tool with a pin having a top in a spherical shape. FIG. 38 shows the result of elongation test at the welded part of SUS304 materials, using the rotary tool with a pin having a top in a spherical shape.

FIG. 37 shows that good welding strength at welded part of SUS304 materials is obtained under the condition of 420 mm/min or smaller welding speed, 600 rpm of rotational speed, and 0.7 or smaller rotational pitch, and specifically at 300 mm/min or smaller welding speed, 600 rpm of rotational speed, and 0.5 or smaller rotational pitch. As seen in FIG. 38, an adequate value of the elongation at welded part of SUS304 materials was obtained under the condition of 300 mm/min or smaller welding speed, 600 rpm of rotational speed, and 0.5 or smaller rotational pitch. From these results, when SUS304 materials are welded together using a rotary tool with a pin having a top in a spherical shape, it is expected to obtain good welding strength at the welded part of SUS304 materials if only the value of {(the rotational speed of the rotary tool [rpm] ×the shoulder diameter [mm]³)/the moving speed of the rotary tool [mm/min]/the plate thickness [mm]} is 3.2×10³ or larger.

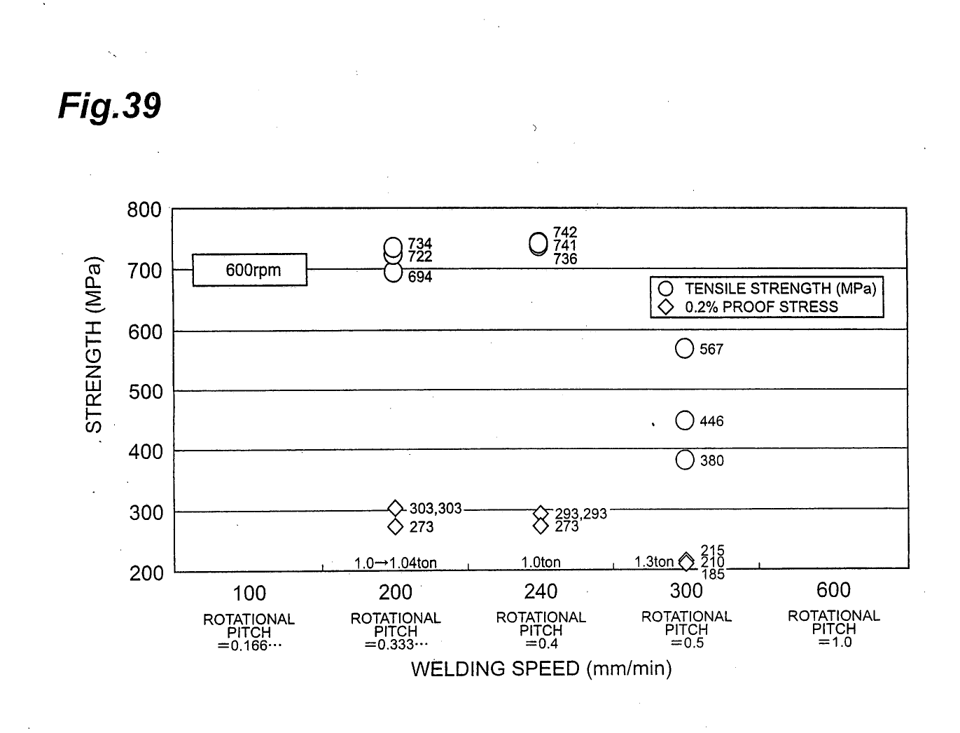

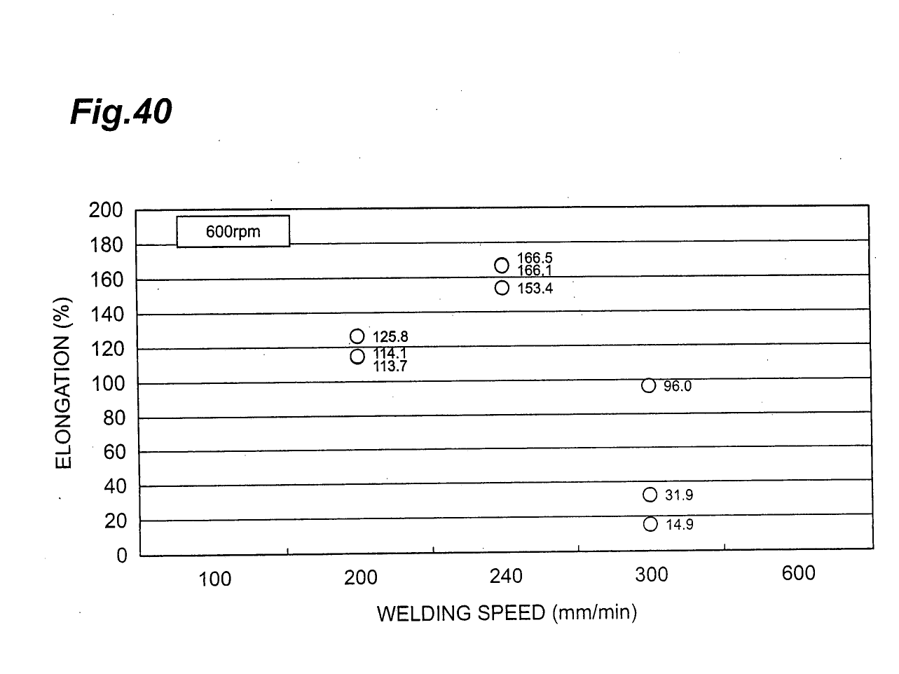

FIG. 39 shows the result of tensile test at the welded part of SUS304 materials, using the rotary tool with a pin in a polygonal prism shape. FIG. 40 shows the result of elongation test at the welded part of SUS304 materials, using the rotary tool with a pin in a polygonal prism shape. FIG. 39 shows that almost good welding strength at welded part of SUS304 materials is obtained under the condition of 300 mm/min or smaller welding speed, 600 rpm of rotational speed, and 0.5 or smaller rotational pitch. As seen in FIG. 40, an adequate value of the elongation at welded part of SUS304 materials was attained under the condition of 300 mm/min or smaller welding speed, 600 rpm of rotational speed, and 0.5 or smaller rotational pitch.

By summarizing the above results, with a rotary tool with a pin having a top in a spherical shape provides almost good welded part of SUS304 materials under the condition of 420 mm/min or smaller welding speed, 0.7 or smaller rotational pitch, and 3.2×10³ or larger value of {(the rotational speed of the rotary tool [rpm] ×the shoulder diameter [mm]³)/the moving speed of the rotary tool [mm/min]/the plate thickness [mm]}. With a rotary tool with a pin having a top in a conical shape and with a rotary tool with a pin having a top in a polygonal prism shape provide good welded part of SUS304 materials under the condition of 300 mm /min or smaller welding speed, 0.5 or smaller rotational pitch, and 4.5×10³ or larger value of {(the rotational speed of the rotary tool [rpm]×the shoulder diameter [mm]³)/the moving speed of the rotary tool [mm/min]/the plate thickness [mm]}. Consequently, it was found that the welding method of the second embodiment is able to favorably weld SU304 materials having 1.5 mm of thickness using a rotary tool having 15 [mm] of shoulder diameter under the condition of 600 [rpm] of rotational speed and 0.1 to 0.7 [mm/r] of rotational pitch. According to the welding method of the second embodiment, SUS304 materials are favorably welded together at the value of {(the rotational speed of the rotary tool [rpm]×the shoulder diameter [mm]³)/the moving speed of the rotary tool [mm/min]/the plate thickness [mm]} in a range from 3.2×10³ to 22.5×10³, inclusive. Accordingly, even with a rotary tool with a pin having a top in a conical shape and with a rotary tool with a pin having a top in a spherical shape, better welding strength at the welded part of SUS304 materials is attained than that obtained by the conventional rotary tool with a pin in a polygonal prism shape. In addition, since the pin is not in a polygonal prism shape, the life of rotary tool prolongs, and the manufacture of rotary tool becomes easy.

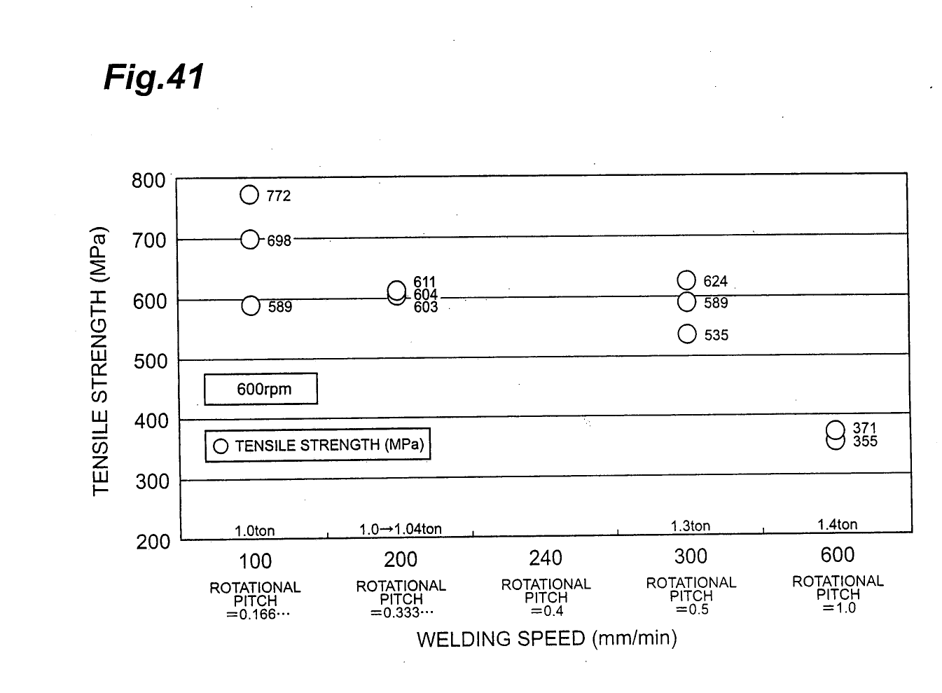

FIG. 41 shows the result of tensile test at the welded part of SUS301L-DLT materials, using the rotary tool with a pin having a top in a conical shape. FIG. 41 shows that almost good welding strength at welded part of SUS301L-DLT materials is obtained under the condition of 300 mm/min or smaller welding speed, 600 rpm of rotational speed, and 0.5 or smaller rotational pitch. The result suggests that a rotary tool with a pin having a top in a conical shape provides almost good welding strength at the welded part of SUS304-DLT materials under the condition of 4.5×10³ or larger value of {(the rotational speed of the rotary tool [rpm]×the shoulder diameter [mm]³)/the moving speed of the rotary tool [mm/min]/the plate thickness [mm]}.

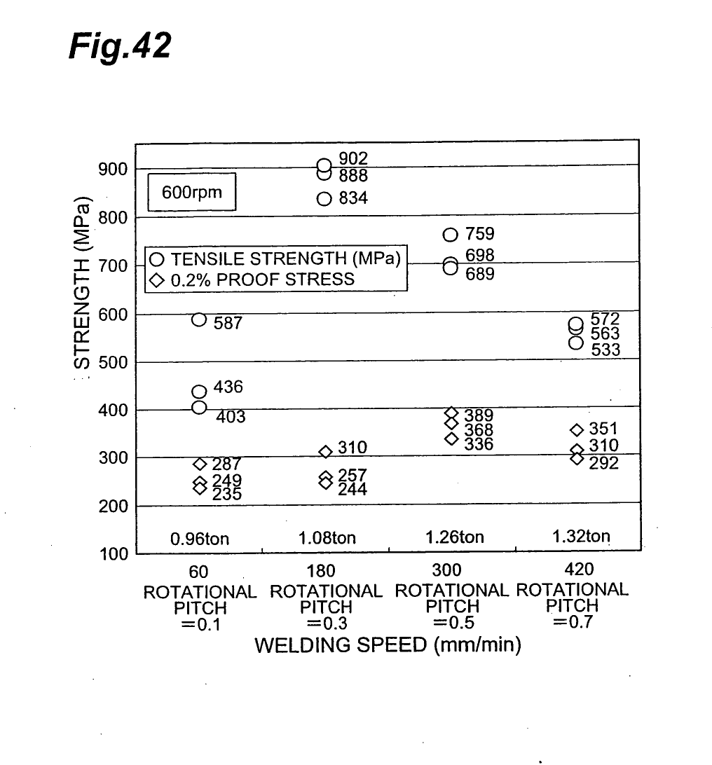

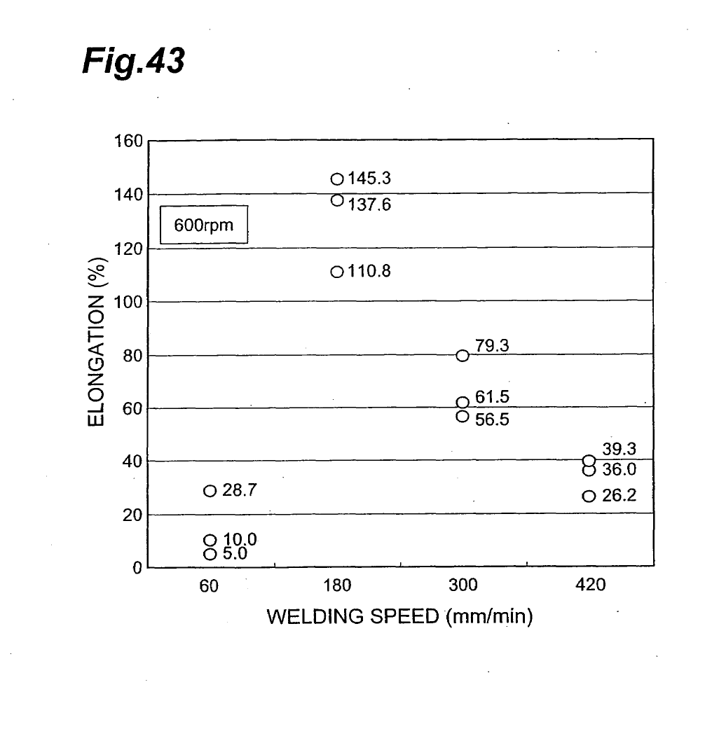

FIG. 42 shows the result of tensile test at the welded part of SUS301L-DLT materials, using the rotary tool with a pin having a top in a spherical shape. FIG. 43 shows the result of elongation test at the welded part of SUS301L-DLT materials, using the rotary tool with a pin having a top in a spherical shape. FIG. 42 shows that almost good welding strength at welded part of SUS301L-DLT materials is obtained under the condition of 180 to 300 mm/min of welding speed, 600 rpm of rotational speed, and 0.3 to 0.5 of rotational pitch. As seen in FIG. 43, also an adequate elongation value at the welded part was obtained under the condition of 180 to 300 mm/min of welding speed, 600 rpm of rotational speed, and 0.3 to 0.5 of rotational pitch. From these results, it is expected that, with a rotary tool with a pin having a top in a spherical shape, almost good welding strength at welded part of SUS301L-DLT materials is obtained under the condition of 4.5×10³ to 7.5×10³ of {(the rotational speed of the rotary tool [rpm]×the shoulder diameter [mm]³)/the moving speed of the rotary tool [mm/min]/the plate thickness [mm]}.

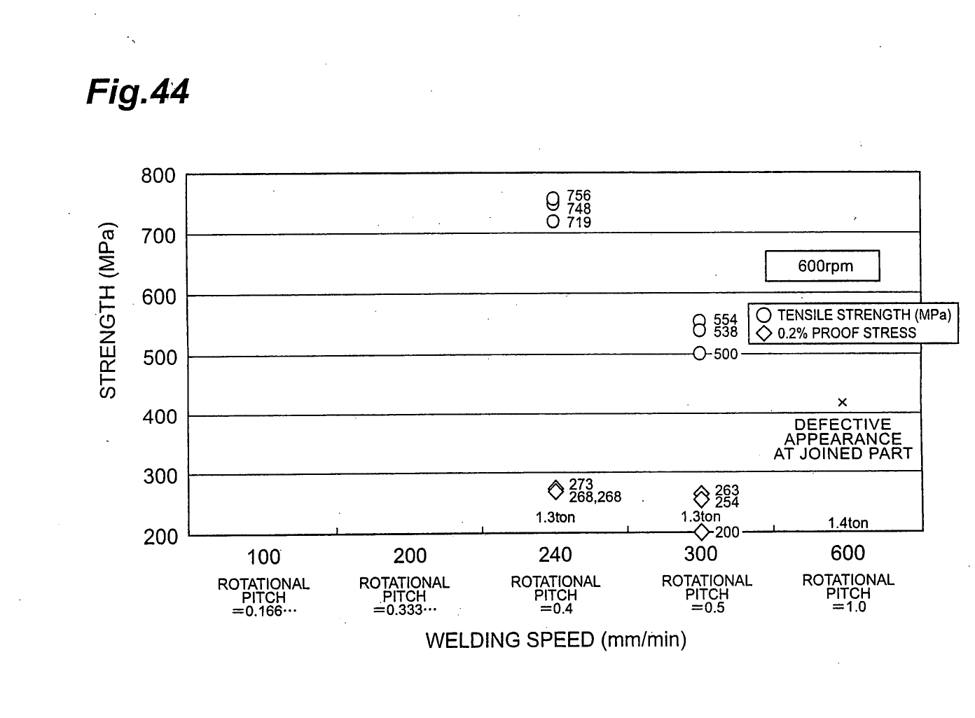

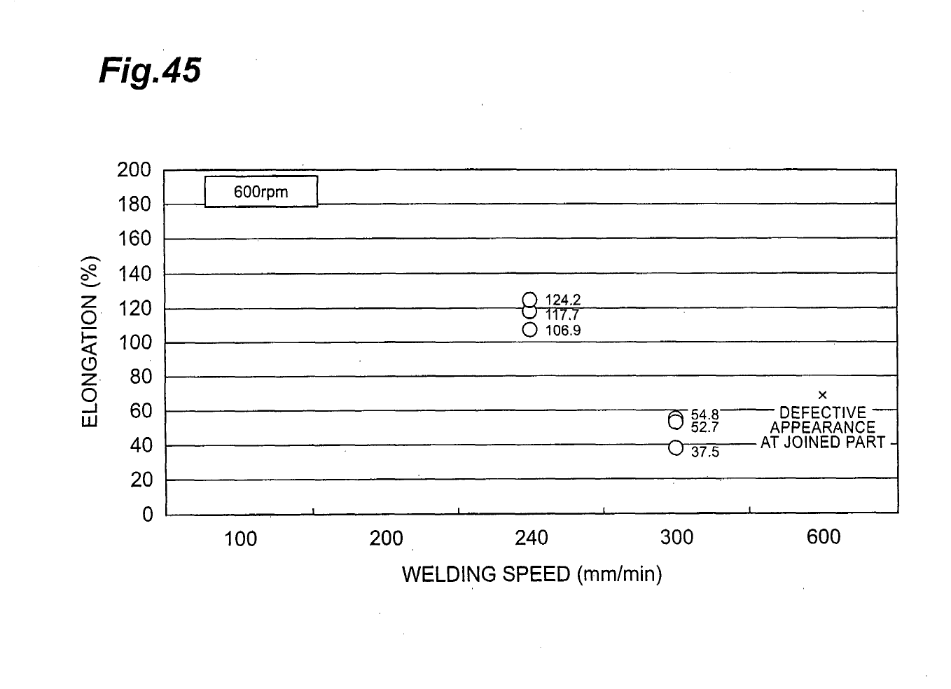

FIG. 44 shows the result of tensile test at the welded part of SUS301L-DLT materials, using the rotary tool with a pin in a polygonal prism shape. FIG. 45 shows the result of elongation test at the welded part of SUS301L-DLT materials, using the rotary tool with a pin in a polygonal prism shape. FIG. 44 shows that almost good welding strength at welded part of SUS301L-DLT materials is obtained under the condition of 300 mm/min or smaller welding speed, 600 rpm of rotational speed, and 0.5 or smaller rotational pitch. As seen in FIG. 45, also an adequate elongation value at the welded part was obtained under the condition of 300 mm/min or smaller welding speed, 600 rpm of rotational speed, and 0.5 or smaller rotational pitch.

By summarizing the above results, with a rotary tool with a pin having a top in a conical shape, with a rotary tool with a pin having a top in a spherical shape, and with a rotary tool with a pin in a polygonal prism shape provide almost good welded part of SUS301L-DLT materials under the condition of 180 to 300 mm/min of welding speed, 0.3 to 0.5 of rotational pitch, and 4.5×10³ to 7.5×10³ of {(the rotational speed of the rotary tool [rpm]×the shoulder diameter [mm]³)/the moving speed of the rotary tool [mm/min]/the plate thickness [mm]}. Accordingly, with a rotary tool with a pin having s top in a conical shape and with a rotary tool with a pin having a top in a spherical shape provide welding strength at the welded part equivalent to that obtained by welding the materials using a conventional rotary tool with a pin in a polygonal prism shape at top thereof. In addition, since the pin is not in a polygonal prism shape, the life of rotary tool prolongs, and the manufacture of rotary tool becomes easy.

By summarizing the above results, as a tendency of welding in SUS304 materials and SUS304-DLT materials, good welded part is obtained under the condition of, at least, 180 to 300 mm/min of welding speed, 0.3 to 0.5 of rotational pitch, and 4.5×10³ to 7.5×10³ of {(the rotational speed of the rotary tool [rpm]×the shoulder diameter [mm]³)/the moving speed of the rotary tool [mm/min]/the plate thickness [mm]}.

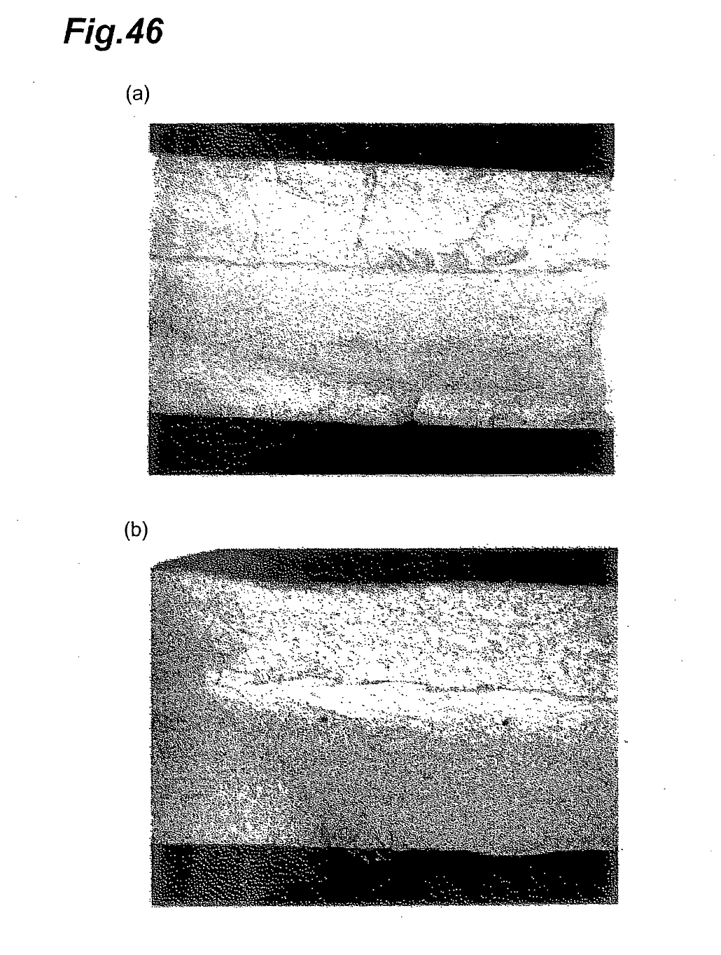

FIGS. 46(a) and 46(b) show the cross sections of welded part in Experimental Example 7, at different welding speeds, rotational speeds, and rotational pitches. FIG. 46 is the cross sectional photographs of the welded part obtained by a rotary tool with a pin having a top in a conical shape. FIG. 46(a) shows a photograph of cross section obtained under the condition of 600 rpm of rotational speed, 200 mm/min of welding speed, and 0.333 of rotational pitch, while FIG. 46(b) shows a photograph of cross section obtained under the condition of 600 rpm of rotational speed, 300 mm/min of welding speed, and 0.5 of rotational pitch.

As seen in FIG. 46(a), both welded parts generated no defect. Consequently, the good welding strength as shown in FIG. 35 was obtained presumably caused by the non-defective welded part.

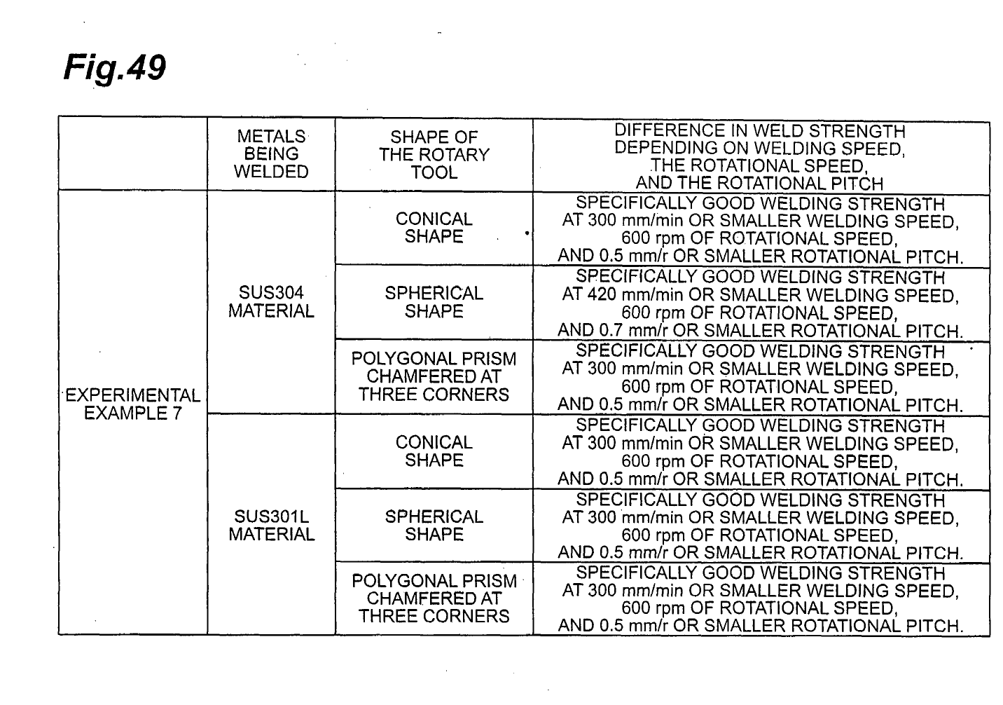

The results of Experimental Example 7 are summarized in FIG. 49 as a comparative table.

The method for welding metals according to the present invention is not limited to the above embodiments, and can be modified in various ways within the range not departing from the scope of the present invention.

### INDUSTRIAL APPLICABILITY

The present invention provides a method for welding metals which increases the life of rotary tool, and decreases the works for manufacturing the rotary tool and the manufacturing cost thereof.

1. A method for welding metals comprising the steps of: butting two metallic members at each side edge thereof; and inserting a pin in a right-cylindrical shape formed at a front end of a rotary tool in a rod shape in between the respective side edges of the two metallic members, thereby moving the pin along the longitudinal direction of the side edges while rotating the rotary tool.

2. The method for welding metals according to claim 1, wherein the rotary tool has a shoulder in a cylindrical shape having larger diameter than that of the pin, the pin is formed at an end face of the shoulder, each of the two metallic members is a plate of A1050 specified by JIS H 4000, having a thickness of 5.0 mm, the diameter of the shoulder is 15 mm, the rotational speed of the rotary tool is 1500 rpm, and the value of (the moving speed of the rotary tool [mm/min] the rotational speed of the rotary tool [rpm]) is 0.28 or larger.

3. The method for welding metals according to claim 1, wherein the rotary tool has a shoulder in a cylindrical shape having larger diameter than that of the pin, the pin is formed at an end face of the shoulder, each of the two metallic members is a plate of A1050 specified by JIS H 4000, and the value of {(the rotational speed of the rotary tool [rpm]×the shoulder diameter [mm]³)/the moving speed of the rotary tool [mm/min]/the plate thickness [mm]} is 2.41×10³ or larger.

4. The method for welding metals according to claim 1, wherein the rotary tool has a shoulder in a cylindrical shape having larger diameter than that of the pin, the pin is formed at an end face of the shoulder, each of the two metallic members is a plate of A6N01 specified by JIS H 4100, having a thickness of 3.1 mm, the diameter of the shoulder is 12 mm, the rotational speed of the rotary tool is 1000 rpm, and the value of (the moving speed of the rotary tool [mm/min] the rotational speed of the rotary tool [rpm]) is 0.3 or larger.

5. The method for welding metals according to claim 1, wherein the rotary tool has a shoulder in a cylindrical shape having larger diameter than that of the pin, the pin is formed at an end face of the shoulder, each of the two metallic members is a plate of A6N01 specified by JIS H 4100, and the value of {(the rotational speed of the rotary tool [rpm]×the shoulder diameter [mm]³)/the moving speed of the rotary tool [mm/min]/the plate thickness [mm]} is 1.86×10³ or larger.

6. The method for welding metals according to claim 1, wherein the rotary tool has a shoulder in a cylindrical shape having larger diameter than that of the pin, the pin is formed at an end face of the shoulder, each of the two metallic members is a plate of A6061 specified by JIS H 4000, having a thickness of 5.0 mm, the diameter of the shoulder is 15 mm, the rotational speed of the rotary tool is 1500 rpm, and the value of (the moving speed of the rotary tool [mm/min] the rotational speed of the rotary tool [rpm]) is 0.2 or larger.

7. The method for welding metals according to claim 1, wherein the rotary tool has a shoulder in a cylindrical shape having larger diameter than that of the pin, the pin is formed at an end face of the shoulder, each of the two metallic members is a plate of A6061 specified by JIS H 4000, and the value of {(the rotational speed of the rotary tool [rpm]×the shoulder diameter [mm]³)/the moving speed of the rotary tool [mm/min]/the plate thickness [mm]} is 3.38×10³ or larger.

8. The method for welding metals according to claim 1, wherein the rotary tool has a shoulder in a cylindrical shape having larger diameter than that of the pin, the pin is formed at an end face of the shoulder, each of the two metallic members is a plate of A5083 specified by JIS H 4000, having a thickness of 5.0 mm, the diameter of the shoulder is 15 mm, the rotational speed of the rotary tool is 600 rpm or less, and the value of (the moving speed of the rotary tool [mm/min]/the rotational speed of the rotary tool [rpm]) is in a range from 0.05 to 0.20 inclusive.

9. The method for welding metals according to claim 1, wherein the rotary tool has a shoulder in cylindrical shape having larger diameter than that of the pin, the pin is formed at an end face of the shoulder, each of the two metallic members is a plate of A5083 specified by JIS H 4000, and the value of {(the rotational speed of the rotary tool [rpm]×the shoulder diameter [mm]³)/the moving speed of the rotary tool [min/min]/the plate thickness [mm]} is in a range from 3.38×10³ to 13.5×10³ inclusive.

10. The method for welding metals according to claim 1, wherein the rotary tool has a shoulder in a cylindrical shape having larger diameter than that of the pin, the pin is formed at an end face of the shoulder, each of the two metallic members is a plate of A2017 specified by JIS H 4000, having a thickness of 5.0 mm, the diameter of the shoulder is 15 mm, the rotational speed of the rotary tool is 600 rpm or less, and the value of (the moving speed of the rotary tool [mm/min]/the rotational speed of the rotary tool [rpm]) is in a range from 0.04 to 0.50 inclusive.

11. The method for welding metals according to claim 1, wherein the rotary tool has a shoulder in a cylindrical shape having larger diameter than that of the pin, the pin is formed at an end face of the shoulder, each of the two metallic members is a plate of A2017 specified by JIS H 4000, and the value of {(the rotational speed of the rotary tool [rpm]×the shoulder diameter [mm]³)/the moving speed of the rotary tool [mm/min]/the plate thickness [mm]} is in a range from 1.35×10³ to 16.9×10³ inclusive.
